(19) United States
(12) Patent Application Publication
(10) Pub. No.: US 2026/0074916 A1
(43) Pub. Date: Mar. 12, 2026

(54) SYSTEMS AND METHODS FOR PRESIGNATURE AND SIGNATURE GENERATION

(71) Applicant: Dfns US Inc, Brooklyn, NY (US)

(72) Inventors: Jonathan KATZ, Silver Spring, MD (US); Antoine URBAN, Strasbourg (FR)

(21) Appl. No.: 18/827,334

(22) Filed: Sep. 6, 2024

(51) Int. Cl. H04L 9/32; H04L 9/14

(52) U.S. Cl. CPC H04L 9/3252; H04L 9/14

(57) ABSTRACT

Some embodiments are directed to a system and methods for presignature and signature generation, the system comprising a plurality of signing devices and a coordinating system. Each signing device stores a share of each of multiple private keys, and is configured to compute one or more presignatures, independent of the multiple private keys; locally store the one or more presignatures; upon receiving from the coordinating system a selection for a private key, generate a share of a signature for a message, using a presignature out of the one or more presignatures computed and stored in the presigning phase; and to send the generated share of the signature for the message to the coordinating system. The coordinating system is configured to send the selection for a private key to one or more of the signing devices, and combine the generated shares of the signature for the message into a signature.

### TECHNICAL FIELD

The presently disclosed subject matter relates to a system for presignature and signature generation. The presently disclosed subject matter further relates to a signing device, and a coordinating system. The presently disclosed subject matter further relates to a presignature and signature generation method for a signing device, and a signature generation method for a coordinating system. The presently disclosed subject matter further relates to a non-transitory computer readable medium comprising data representing instructions, which, when executed by a processor system, cause the processor system to perform a presignature and signature generation method for a signing device. The presently disclosed subject matter further relates to a non-transitory computer readable medium comprising data representing instructions, which, when executed by a processor system, cause the processor system to perform a signature generation method for a coordinating system. The presently disclosed subject matter further relates to a non-transitory computer readable medium storing one or more presignatures.

### BACKGROUND

Threshold Elliptic Curve Digital Signature Algorithm (ECDSA) signatures are needed in several settings which require a high level of security. In these threshold protocols for ECDSA, private keys are shared by a plurality of signers, say n signing devices P₁, . . . , Pₙ, who together are able to run an interactive protocol to generate signatures for those private keys. In the so-called honest-majority setting, the system should remain secure even against an adversary who may corrupt any number t<n/2 of the signing devices.

There exist several protocols for generating threshold ECDSA signatures: see, for example, Damgård et al. (2022): Fast threshold ECDSA with honest majority, Pettit (2021): Efficient threshold-optimal ECDSA, Dalskov et al. (2020): Securing DNSSEC keys via threshold ECDSA from generic MPC, Gągol et al. (2020): Threshold ECDSA for decentralized asset custody. The existing schemes employ several techniques to enforce security against malicious behavior in an honest-majority setting.

Unfortunately, the existing schemes only consider a single execution of the signing and presigning protocols, as well as signing devices holding shares of only a single key.

There is a need to improve systems for generating threshold ECDSA signatures in an honest-majority setting, so that a setting where signing devices hold shares of multiple private keys is considered.

It would be advantageous to have an improved signing and presigning protocol for a setting in which signing devices holding shares corresponding to multiple keys.

### SUMMARY

An improved signing and presigning protocol is described in the accompanying claims, the protocol supporting batch generation of presignatures in a setting in which signing devices hold shares corresponding to multiple keys, where the presignatures generated by those signing devices may be used for any one of the multiple keys: so, key-independent presignature generation in a network of signing devices holding shares for multiple keys.

In an embodiment of the system for presignature and signature generation, the system may comprise a plurality of signing devices and a coordinating system, wherein each of the plurality of signing devices stores a share of each of multiple private keys.

A presigning phase may comprise computing one or more presignatures by the plurality of signing devices. The presignatures may comprise an intermediate value in generating a signature for a message, wherein the presignature is independent of the message to be signed. Each of the plurality of signing devices may, in the presigning phase, compute one or more presignatures independent of the multiple private keys which are shared by the signing devices: e.g., not using the private key shares they store. As a result of the presigning phase, batch generation of presignatures may take place. In a signing phase following the presigning phase, signing may be done non-interactively using only one of the generated presignatures when a message to be signed is known. It may be chosen to use each presignature only once, in order to ensure a high security level.

For example, a presignature, which may be used in a threshold ECDSA setting, may correspond to a share of an inverse of a random integer k, and to F(g^{k}), wherein F is a function that depends on the exact signature scheme which is used, and g is a generator of a multiplicative group used in the exact setting. The usage of presignatures may reduce the amount of computations in the threshold ECDSA setting by at least 10%, more preferably at least 20%.

To initiate and coordinate the execution of the different phases of the protocol among the various signing devices, a coordinating system may be used. The coordinating system may be distinct from the signing devices. The coordinating system may hold the public keys which are associated with the private keys shared by the signing devices. The coordinating system may determine and communicate a selection for a private key, a selection of a presignature, and/or which messages get signed by the signing devices.

In accordance with a first aspect of the invention, a system is provided for presignature and signature generation, wherein the system comprises a plurality of signing devices and a coordinating system, wherein each of the plurality of signing devices stores a share of each of multiple private keys, wherein
each of the plurality of signing devices comprises one or more processors and one or more storage devices storing instructions that, when executed by the one or more processors, cause the one or more processors to perform operations for
in a presigning phase,
   computing one or more presignatures, independent of the multiple private keys, and
   locally storing the one or more presignatures,

and
in a signing phase, upon receiving from the coordinating system a selection for a private key out of the multiple private keys,
   generating a share of a signature for a message, using a presignature out of the one or more presignatures computed and stored in the presigning phase, and
   sending the generated share of the signature for the message to the coordinating system,
and
the coordinating system comprises one or more processors and one or more storage devices storing instructions that, when executed by the one or more processors, cause the one or more processors to perform operations for
   sending the selection for a private key to one or more of the signing devices,
   upon receiving the generated shares of the signature for a message from one or more of the plurality of signing devices, combining the generated shares of the signature for the message into a signature.

In accordance with a further aspect of the invention, a signing device is provided, storing a share of each of multiple private keys, which comprises one or more processors and one or more storage devices storing instructions that, when executed by the one or more processors, cause the one or more processors to perform operations for
in a presigning phase,
computing one or more presignatures independent of the multiple private keys, and
locally storing the one or more presignatures,

and
in a signing phase, upon receiving from a coordinating system a selection for a private key out of the multiple private keys,
generating a share of a signature for a message, using a presignature out of the one or more presignatures computed and stored in the presigning phase, and
sending the generated share of the signature for the message to the coordinating system.

In accordance with a further aspect of the invention, a coordinating system is provided, comprising one or more processors and one or more storage devices, storing instructions that, when executed by the one or more processors, cause the one or more processors to perform operations for
sending a selection for a private key out of multiple private keys to one or more of a plurality of signing devices,
upon receiving generated shares of a signature for a message from one or more of the plurality of signing devices, combining the generated shares of the signature for the message into the signature.

In accordance with a further aspect of the invention, a presignature and signature generation method for a signing device is provided, the signing device storing a share of each of multiple private keys, the method comprising
in a presigning phase,
computing one or more presignatures, independent of the multiple private keys, and
locally storing the one or more presignatures,

and
in a signing phase, upon receiving from a coordinating system a selection for a private key out of the multiple private keys,
generating a share of a signature for a message, using a presignature out of the one or more presignatures computed and stored in the presigning phase, and
sending the generated share of the signature for the message to the coordinating system.

In accordance with a further aspect of the invention, a signature generation method for a coordinating system is provided, comprising
sending a selection for a private key out of multiple private keys to one or more of a plurality of signing devices,
upon receiving generated shares of a signature for a message from one or more of the plurality of signing devices, combining the generated shares of the signature for the message into the signature.

In accordance with a further aspect of the invention, a non-transitory computer readable medium comprising data representing instructions, which when executed by a processor system, cause the processor system to perform a presignature and signature generation method for a signing device as described in this specification.

In accordance with a further aspect of the invention, a non-transitory computer readable medium is provided comprising data representing instructions, which when executed by a processor system, cause the processor system to perform a signature generation method for a coordinating system as described in this specification.

In accordance with a further aspect of the invention, a non-transitory computer readable medium is provided storing one or more presignatures, the one or more presignatures being computed by a signing device, the signing device storing a share of each of multiple private keys, the signing device being configured to compute the one or more presignatures, independent of the multiple private keys, the signing device being further configured to locally store the one or more presignatures.

Several advantages are associated with the system for presignature and signature generation.

The above measures allow a large number of presignatures to be generated by the plurality of signing devices in this multi-party signing protocol at better amortized cost. Additionally, these measures support a setting where signing devices hold shares of multiple private keys; the presignatures generated by the signing devices can be used for any of the multiple keys, as the presignatures are computed independently of the multiple private keys. A signing protocol as discussed herein can be used in an honest-majority setting of threshold ECDSA.

Optionally, the coordinating system may be configured to send the message to be signed, or possibly a hash of the message to be signed, and/or a selection of a presignature out of the one or more presignatures to one or more of the plurality of signing devices; for example, to each of the signing devices. Optionally, the coordinating system may send a message to be signed, and/or a selection of a presignature out of the one or more presignatures to one or more of the plurality of signing devices directly, after which the one or more of the plurality of signing devices may forward the message to be signed, and/or the selection of a presignature out of the one or more presignatures to the other signing devices out of the plurality of signing devices, creating a forwarding system following a tree structure. The signing devices may then receive from the coordinating system the message to be signed, or the hash of the message to be signed, and/or the selection for the presignature.

Optionally, the presignature which is used to generate a share of a signature is securely erased from the signing device after being used. Securely erasing a presignature improves the overall security of the presignature and signature generation system.

Optionally, the coordinating system, which stores at least one public key corresponding to the multiple private keys, may be further configured to, after combining the generated shares of the signature for the message into the final signature, verify the signature using a public key that corresponds to the selected private key. This verification improves the security of the system. The coordinating system need not communicate directly with any signing device for the verification.

Optionally, each of the plurality of signing devices may communicate with one or more other signing devices and/or the coordinating system during the presigning phase. A signing device need not communicate directly with other signing devices or the coordinating system, but instead may communicate through a communicating device, which can be another signing device or an external device. This configuration allows for intermediaries and additional services without burdening the signing devices or coordinating system.

Optionally, the system may further designate one or more of the signing devices to a set of the signing devices. A designated device may comprise a communicating device as discussed above. Instead of a trusted dealer or a complex protocol as in the prior art, the designated device may choose a cryptographic key, e.g., a uniform key and send it via a private channel to each signing device in the set for which it has been designated. The signing devices for which the designated device is designated may be configured to receive the key, and may further be configured to generate shares of a zero value and/or a random value using the received key. This is more efficient and still as secure as in the prior art, as the key may be chosen uniformly and independently of the other keys, shared correctly among the appropriate signing devices.

The system for presignature and signature generation may be an electronic system. The signing devices and the coordinating system may comprise electronic devices; they may comprise a computer.

The methods for signature and presignature generation as described herein may be applied in a wide range of practical applications, such as whenever high-security signing may be needed. The methods as described herein may be implemented on devices, such as cryptographic devices. A signing device as described above may be a cryptographic device. A coordinating system as described above may be comprised in one or more cryptographic devices. The cryptographic devices may be electronic devices. For example, they may be computers. They may be mobile electronic devices, e.g., a mobile phone, a smart card. The cryptographic devices may be consumer electronics, e.g., a set-top box, a television. It may be an electronic device, in particular a computer.

An embodiment of the methods may be implemented on a computer as a computer-implemented method or in dedicated hardware, or in a combination of both. Executable code for an embodiment of the method may be stored on a computer program product. Examples of computer program products include memory devices, optical storage devices, integrated circuits, servers, and online software, etc. Preferably, the computer program product comprises non-transitory program code stored on a computer readable medium for performing an embodiment of the method when said program product is executed on a computer. It may be able to carry out the methods mentioned above. It may be a mobile electronic device, e.g., a smartphone.

On a computer, the methods may be implemented as new software, or a new software feature of some existing software application. Executable code for an embodiment of the method may be stored on a computer program product. Examples of computer program products include memory devices, optical storage devices, integrated circuits, servers, online software, etc. Preferably, the computer program product comprises non-transitory program code stored on a computer-readable medium for performing an embodiment of the method when said program product is executed on a computer.

In an embodiment, a computer program may comprise computer program code adapted to perform all or part of the phases of an embodiment of the method, when the computer program is run a computer. Preferably, the computer program may be embodied on a computer-readable medium.

The embodiments as mentioned above are described in the accompanying claims. Further, specific embodiments are set forth in the dependent claims.

### BRIEF DESCRIPTION OF DRAWINGS

Further details, aspects, and embodiments will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIG. 1a schematically shows an example of an embodiment of a signing device,

FIG. 1b schematically shows an example of an embodiment of a coordinating system,

FIGS. 1c-1f schematically shows examples of embodiments of a system for presignature and signature generation or parts thereof,

FIG. 2 schematically shows an example of a sequence diagram for a system for presignature and signature generation,

FIG. 3a schematically shows an example of an embodiment of a signing device with a key storage,

FIG. 3b schematically shows an example of an embodiment of a coordinating system connected to a signing device,

FIG. 4a schematically shows an example of an embodiment of a presignature and signature generation method for a signing device,

FIG. 4b schematically shows an example of an embodiment of a signature generation method for a coordinating system,

FIG. 5a schematically shows a computer readable medium having a writable part comprising a computer program according to an embodiment,

FIG. 5b schematically shows a representation of a processor system according to an embodiment.

### REFERENCE SIGNS LIST

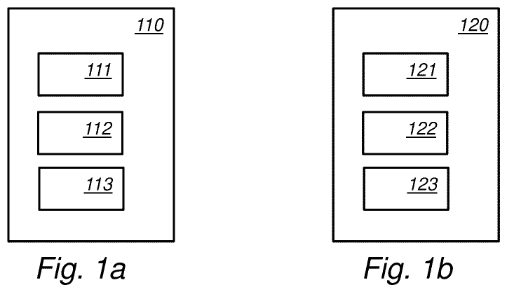

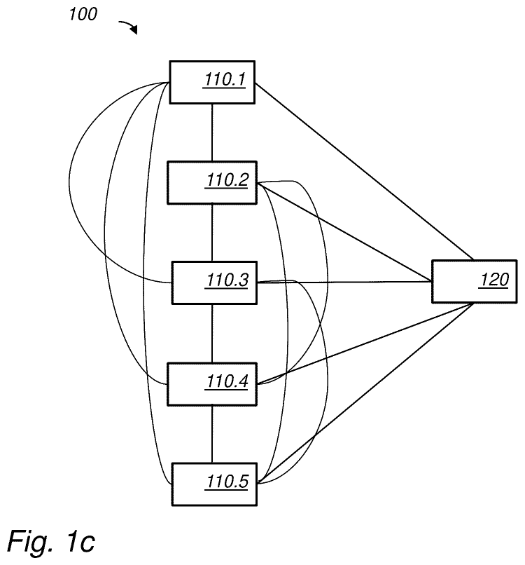

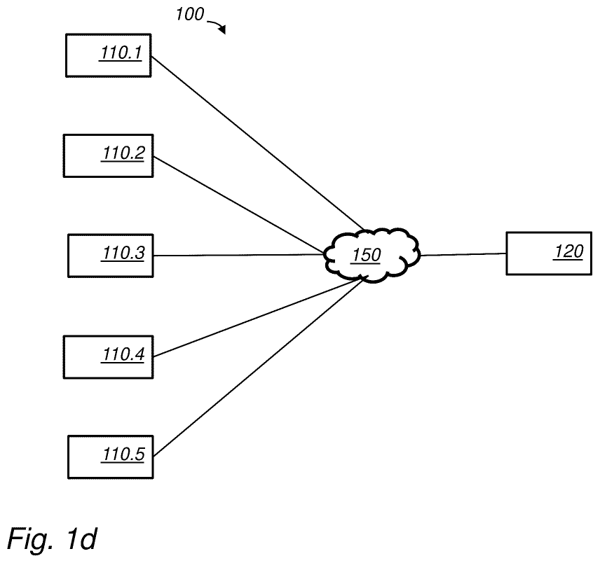

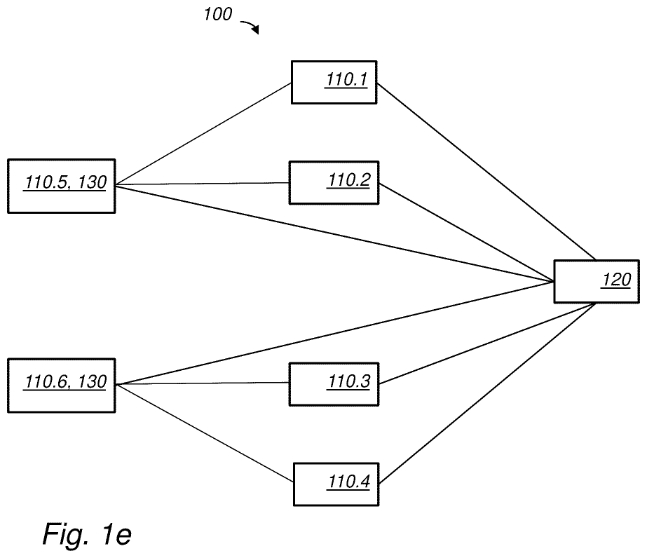

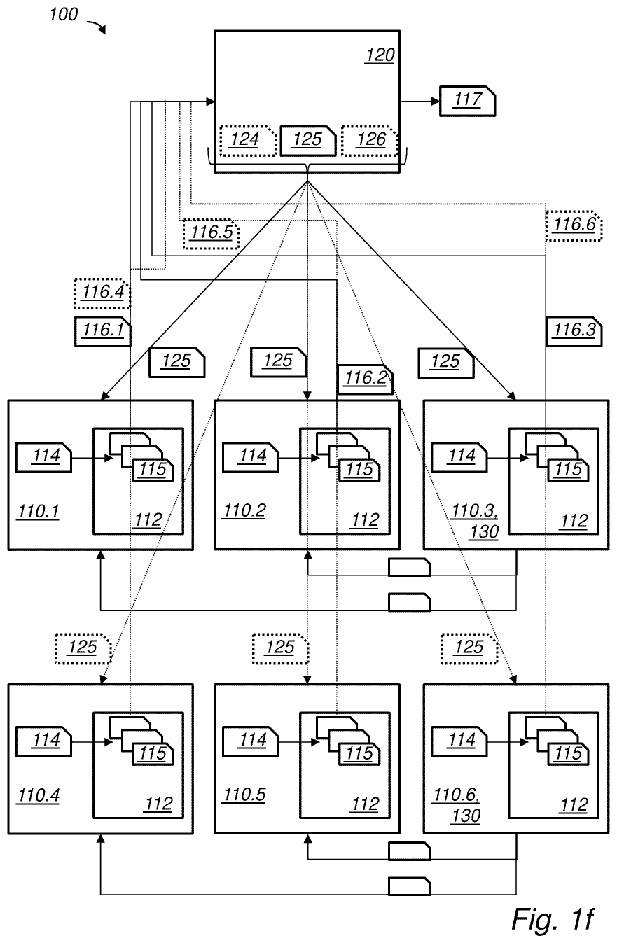

The following list of references and abbreviations corresponds to FIGS. 1-8b, and is provided for facilitating the interpretation of the drawings and shall not be construed as limiting the claims.
100 system for presignature and signature generation
110, 110.1-6 signing devices
111 processor
112 storage device
113 communication interface
114 computations
115 presignature
116, 116.1-3 share of signatures
117 signature
120 coordinating system
121 processor
122 storage device
123 communication interface
124 message to be signed
125 selection for a private key
126 selection for a presignature
130 designated device
140 other signing devices
141 private key shares
142 key storage
143 public key
144 key storage
150 computer network
200 sequence diagram for a system for presignature and signature generation
201 performing computations
202 sharing a result of the computations with one or more designated devices
203 forwarding a result of the computations
204 locally storing another result of the computations
205 sending a selection for a private key out of the multiple private keys, and optionally a message to be signed and/or a selection for a presignature
206 generating a share of a signature
207 sending the generated share of the signature
208 combining generated shares of the signature into the signature
209 verifying the signature using a public key
210 presigning phase
220 signing phase
400 presignature and signature generation method for a signing device
401 receiving from a coordinating system a selection for a private key out of the multiple private keys
500 signature generation method for a coordinating system
501 receiving generated shares of a signature for a message from one or more of a plurality of signing devices
1000, 1001 a computer-readable medium
1010 a writable part
1020 a computer program
1110 integrated circuit(s)
1120 a processing unit
1122 a memory
1124 a dedicated integrated circuit
1126 a communication element
1130 an interconnect
1140 a processor system

### DESCRIPTION OF EMBODIMENTS

While the presently disclosed subject matter is susceptible of embodiment in many different forms, there are shown in the drawings and will herein be described in detail one or more specific embodiments, with the understanding that the present disclosure is to be considered as exemplary of the principles of the presently disclosed subject matter and not intended to limit it to the specific embodiments shown and described.

In the following, for the sake of understanding, elements of embodiments are described in operation. However, it will be apparent that the respective elements are arranged to perform the functions being described as performed by them.

Further, the subject matter that is presently disclosed is not limited to the embodiments only, but also includes every other combination of features described herein or recited in mutually different dependent claims.

FIG. 1a schematically shows an example of an embodiment of a signing device 110. FIG. 1b schematically shows an example of an embodiment of a coordinating system 120. Signing device 110 and coordinating system 120 may be part of a system 100 for presignature and signature generation, further illustrated in FIGS. 1c-1e. These figures schematically show examples of embodiments of the system 100 for presignature and signature generation and its parts.

Signing device 110 may compute and locally store one or more presignatures, independent of private keys, and generate and send shares of signatures for messages using a computed and stored presignature. Coordinating system 120 may send a selection for a private key to signing devices and combine received generated shares of a signature into a final signature. Signing device 110 may communicate internally in a point-to-point network model. While a broadcasting mode is possible, it is not needed.

Signing devices 110 may comprise a processor system 111 comprising one or more processors, one or more storage devices 112, and a communication interface 113. Coordinating system 120 may comprise a processor system 121 comprising one or more processors, one or more storage devices 122, and a communication interface 123. Storage device 122 may comprise a memory. The memory may store instructions that, when executed by processor system 111, cause processor system 111 to perform operations for executing a method.

The communication interfaces 113 and/or 123 may be selected from various alternatives. For example, the interface may be a network interface to a local or wide area network, e.g., the Internet, a storage interface to an internal or external data storage, an application interface (API), etc.

Storage devices 112 and/or 122 may be, e.g., electronic storage, magnetic storage, etc. The storage may comprise local storage, e.g., a local hard drive or electronic memory. Storage 112 and 122 may comprise non-local storage, e.g., cloud storage. In the latter case, storage 112 and 122 may comprise a storage interface to the non-local storage. Storage may comprise multiple discrete sub-storages together making up storage 112, 122. Storage may comprise a volatile writable part, say a RAM, a non-volatile writable part, e.g., Flash, a non-volatile non-writable part, e.g., ROM.

Storage 112 and 122 may comprise non-transitory storage. For example, storage 112 and 122 may store data in the presence of power such as a volatile memory device, e.g., a Random Access Memory (RAM). For example, storage 112 and 122 may store data in the presence of power as well as outside the presence of power such as a non-volatile memory device, e.g., Flash memory. Memory 120 may comprise a non-volatile non-writable part, e.g., ROM, e.g., storing part of the software.

Devices 110 and 120 may communicate internally, with each other, with other devices, external storage, input devices, output devices, and/or one or more biometric sensors over a computer network. The computer network may be an internet, an intranet, a LAN, a WLAN, etc. The computer network may be the Internet. The devices 110 and 120 may comprise a connection interface which may be arranged to communicate within system 100 or outside of system 100 as needed. For example, the connection interface may comprise a connector, e.g., a wired connector, e.g., an Ethernet connector, an optical connector, etc., or a wireless connector, e.g., an antenna, e.g., a Wi-Fi, ZigBee, a cellular antenna, 4G or 5G antenna.

The communication interfaces 113 may be used to send or receive data, e.g., digital data, e.g., messages to be signed, selections for private keys and/or presignatures, and signature shares for messages to be signed. The communication interface 123 may be used to send or receive digital data, e.g., messages to be signed, selections for private keys and/or presignatures, and signature shares for messages to be signed, and/or signatures.

The communication interface 123 may be used to communicate with other server devices, e.g., external server devices with which signatures may be shared; then the coordinating system 120 may be further configured to send a combined signature to an external service interface via the communication interface 123.

The execution of device 110 and/or system 120 and/or system 100 may be implemented in a processor system. The devices 110 and 120 and/or system 100 may comprise functional units to implement aspects of embodiments. The functional units may be part of the processor system. For example, functional units shown herein may be wholly or partially implemented in computer instructions that are stored in a storage of the device and executable by the processor system. Devices 110 and 120 may be connected through a signing server, e.g., via the Internet.

The processor system may comprise one or more processor circuits, e.g., microprocessors, CPUs, GPUs, etc. Devices 110 and 120 and/or system 100 may comprise multiple processors. A processor circuit may be implemented in a distributed fashion, e.g., as multiple sub-processor circuits. For example, devices 110 and 120 and/or system 100 may use cloud computing via a computer network 150, e.g., a cloud server.

Typically, signing device 110 and coordinating system 120 each comprise a microprocessor executing appropriate software stored at the device; for example, that software may have been downloaded and/or stored in a corresponding memory, e.g., a volatile memory such as RAM or a non-volatile memory such as Flash.

Instead of using software to implement a function, the devices 110 and/or 120 and/or system 100 may, in whole or in part, be implemented in programmable logic, e.g., as field-programmable gate array (FPGA). The devices may be implemented, in whole or in part, as a so-called application-specific integrated circuit (ASIC), e.g., an integrated circuit (IC) customized for their particular use. For example, the circuits may be implemented in CMOS, e.g., using a hardware description language such as Verilog, VHDL, etc. In particular, signing device 110 and coordinating system 120 and/or system 100 may comprise circuits, e.g., for cryptographic processing, and/or arithmetic processing.

In hybrid embodiments, functional units are implemented partially in hardware, e.g., as coprocessors, e.g., cryptographic coprocessors, and partially in software stored and executed on the device.

FIGS. 1c, 1d and 1e schematically show examples of embodiments of a system 100 for presignature and signature generation. System 100 typically comprises a plurality of signing devices 110: shown are five signing devices 110.1-110.5 in FIGS. 1c and 1d, and six signing devices 110.1-110.6 in FIGS. 1e and 1f, but it may be more than six. The signing devices may be according to an embodiment, for example, as described by FIG. 1a. System 100 for presignature and signature generation may comprise multiple coordinating systems; shown is one coordinating system 120, but it may be more than one. The coordinating system may be according to an embodiment, for example, as described by FIG. 1b. Each out of the plurality of signing devices 110 may be configured to communicate with one or more of the plurality of signing devices 110. For example, as shown in FIG. 1c by the connecting edges between the signing devices 110.1-5, each out of the plurality of signing devices 110.1-5 may be configured to communicate with each of the other signing devices: signing device 110.1 may communicate with all of 110.2-110.5, signing device 110.2 may communicate with all of 110.1, 110.3-110.5, signing device 110.3 may communicate with all of 110.1, 110.2, 110.4 and 110.5, signing device 110.4 may communicate with all of 110.1-3 and 110.5, and signing device 110.5 may communicate with all of 110.1-110.4. Optionally, any subgroup of signing devices 110 may only communicate inside the subgroup: e.g., signing devices 110.1, 110.2, 110.5 may communicate only with each other, and not with signing devices 110.3, 110.4 and 110.6; and signing devices 110.3, 110.4 and 110.6 may communicate only with each other, and not with signing devices 110.1, 110.2 and 110.5.

All of signing devices 110, 110.1-110.6 may communicate with coordinating system 120, as shown in FIG. 1c-e by the connecting edges between the signing devices 110.1-5 and coordinating system 120. Optionally, any subgroup of signing devices 110 may communicate with coordinating system 120. As shown in FIG. 1d, signing devices 110 may be connected through a network 150, as shown by the connecting edges between signing devices 110 and network 150. The network may be a computer network 150, e.g., the Internet. Network 150 may comprise additional elements, e.g., a router, a hub, etc. The communication interface may be used to send or receive data. System 100 may be connected to a cloud storage system, to which multiple systems such as system 100 may be connected as well. This may illustrate an option of uploading, storing, sharing, and downloading data.

One or more signing devices 110.5, 110.6 out of the plurality of signing devices 110.1-6 may additionally be designated devices 130, as is shown in FIG. 1e. Designated devices 130 may be designated to a set of the signing devices 110. For example, designated device 110.5 may be designated to a set of signing devices 110.1, 110.2, and designated device 110.6 may be designated to a set of signing devices 110.3, 110.4. The one or more designated devices 130 may be configured to obtain a key. The one or more designated devices 130 may be configured to send the key to each signing device out of the designated set of signing devices. For example, designated device 110.5 may be configured to obtain a key and send the key to signing device 110.1 and signing device 110.2; and designated device 110.6 may be configured to obtain a key and send the key to signing device 110.3 and signing device 110.4. Each of the plurality of signing devices 110.1-110.6 may further be configured to receive a key from a device 130 designated to a set of signing devices 110 comprising the signing device 110. For example, signing device 110.1 and signing device 110.2 may be configured to receive a key from designated device 110.5; and signing device 110.3 and signing device 110.4 may be configured to receive a key from designated device 110.6. Each of the plurality of signing devices 110.1-110.6 may further be configured to generate shares of a zero value, and/or shares of a random value, using the received key.

A signing system comprising a plurality of signing devices 110 may be configured to create key shares via a distributed key generation protocol, or receive key shares from a trusted party, configured distribute key shares to signing devices 110. Signing devices 110 may comprise key storages for storing a key share. A plurality of key shares may be distributed to the plurality of signing devices 110. Key shares may be created by an external key generating device, and/or distributed by an external key distributing device. Signing device 110 may store a key share of the plurality of key shares in a key storage. The one or more processors of a signing device 110 may retrieve a key share. The storage of a signing device 110 may correspond to a threshold signature scheme. The signing devices 110 and coordinating system 120 may be according to an embodiment.

FIG. 1f shows an example of an embodiment of a system 100 for presignature and signature generation. Shown are signing devices 110.1, 110.2, 110.3, 110.4, 110.5 and 110.6, and a coordinating system 120. Signing devices 110.3 and/or 110.6 may be designated devices 130 as discussed above. Designated device 110.3 may be designated to a set of signing devices 110.1 and 110.2, and/or designated device 110.6 may be designated to a set of signing devices 110.4 and 110.5. Designated device 110.3 may communicate with signing devices 110.1 and 110.2, for example send a key to signing devices 110.1 and 110.2 as discussed above; designated device 110.6 may communicate with signing devices 110.4 and 110.5 as discussed above. System 100 may comprise a plurality of signing devices, of which signing devices 110.1, 110.2, 110.3, 110.4, 110.5 and 110.6 are shown, coordinating system 120. Each of the plurality of signing devices 110.1-6 may be further configured to communicate with one or more of the plurality of signing devices 110.1-6; optional edges between signing devices 110.1-6 are not shown in FIG. 1f.

Each of the plurality of signing devices 110.1-6 may store a share of each of multiple private keys. The multiple private key shares may be generated as discussed above. Each of the plurality of signing devices 110 may be configured to, in a presigning phase, compute one or more presignatures 115. Each of the plurality of signing devices 110 may be configured to perform computations 114. The performed computations 114 may result in one or more presignatures 115. The one or more presignatures 115 may be stored on signing devices 110 in a storage 112. Computing the one or more presignature then happens independently of the multiple private keys. Signing devices 110 may locally store the one or more presignatures 115 in storage 112.

Coordinating system 120 may be configured to send a selection 125 for a private key out of the multiple private keys to one or more of the plurality of signing devices 110. One or more of the plurality of signing devices 110 may be configured to receive selection 125 for a private key out of the multiple private keys from coordinating system 120. Coordinating system 120 may optionally further be configured to additionally send to one or more of the signing devices 110 a message 124 to be signed. The message to be signed 124 may also be sent to one or more of signing devices 110 in a different manner, e.g., externally, via a communicating device or communication interface. Coordinating system 120 may optionally further be configured to additionally send to one or more of signing devices 110 a selection 126 for a presignature 115 out of the one or more presignatures 115. Selection 126 for a presignature 115 out of the one or more presignatures 115 may also be sent to one or more of signing devices 110 in a different manner, e.g., externally, e.g., via a communicating device and/or communication interface. One or more of the plurality of signing devices 110, may further be configured to receive from coordinating system 120 message 124 to be signed, and/or selection 126 for presignature 115 out of one or more presignatures 115 to use, or to receive message 124 to be signed, and/or selection 126 for presignature 115 out of one or more presignatures 115 to use in a different manner, e.g., externally, e.g., from a communicating device and/or communication interface.

One or more of the plurality of signing devices 110 may be configured to, in a signing phase, upon receiving from coordinating system 120 selection 125 for a private key out of the multiple private keys, generate a share 116, 116.1, 116.2, 116.3, 116.4, 116.5, 116.6 of a signature 117 for message 124 to be signed. Signing devices 110 may generate share 116 of signature 117 using presignature 115 out of the one or more presignatures 115, which has been computed and stored by signing devices 110 in the presigning phase. Signing devices 110 may be configured to send generated share 116 of signature 117 for message 124 to coordinating system 120. Coordinating system 120 may be configured to receive generated shares 116.1-6 of signature 117 for message 124 from one or more of the plurality of signing devices 110. Coordinating system 120 may be configured to, upon receiving generated shares 116.1-6 of signature 117 for message 124 from one or more of the plurality of signing devices 110, combine generated shares 116.1-6 of signature 117 for message 124 into signature 117. Presignatures 115 which are used to generate shares 116.1-6 of signature 117 may be securely erased from signing device 110.1-6 after being used to generate shares 116.1-6 of signature 117. Signing devices 110 may be configured to securely erase presignature 115 after using presignature 115 to generate shares 116 of signature 117. Coordinating system 120 may store at least one public key corresponding to the multiple private keys, and may further be configured to, after combining generated shares 116.1-6 of signature 117 for message 124 into the signature 117 for message 124, verify signature 117 using a public key out of the at least one public key corresponding to the selected private key 125 of the multiple private keys. Each of the plurality of signing devices 110 in system 100 may be configured to, in the presigning phase, perform computations 114 resulting in a plurality of presignatures 115, wherein each of the plurality of presignatures 115 is independent of the multiple private keys, enabling batch presignature generation.

Identifying the devices with an integer, e.g., j, for convenience, each device j of the plurality of signing devices 110 in system 100 may be further configured to, during the computing of the one or more presignatures 115, generate a message g^{k}^{_{i,j}} corresponding to a share k_{i,j} of an integer kᵢ, using a generator g of a mathematical group, and send the generated message g^{k}^{_{i,j}} to another signing device 110 out of the plurality of signing devices 110. Each j of the plurality of signing devices 110 in system 100 may further be configured to generate a share k′_{i,j} of an inverse of the random integer kᵢ, and store the generated share k′_{i,j} of the inverse of the random integer kᵢ as part of the one or more presignatures 115.

Furthermore, each of the plurality of signing devices 110 in system 100 may further be configured to, during the computing of the one or more presignatures 115, generate one or more multiplication triples. A multiplication triple comprises shares of two random integers, and a share of the product of the two random integers. Each of the plurality of signing devices 110 in system 100 may further be configured to generate a share of an inverse of a random integer from one or more of the multiplication triples. Each (a_{i,j}, k_{i,j}, w_{i,j}) of the multiplication triples may comprise shares (a_{i,j}, k_{i,j}) of random integers (aᵢ, kᵢ), as well as a share (w_{i,j}) of a product (wᵢ=aᵢ·kᵢ) of the random integers (aᵢ, kᵢ).

Furthermore, each j of the plurality of signing devices 110 may be further configured to send the share w_{i,j} of the product wᵢ=aᵢ·kᵢ of the random integers aᵢ, kᵢ to one or more other signing devices (140) out of the plurality of signing devices (110). Each j of the plurality of signing devices 110 may be further configured to generate a share

$${k}_{i , j}^{′} = {w}_{i}^{- 1} \cdot {a}_{i , j}$$

of the inverse of the random integer kᵢ corresponding to a multiplication triple (a_{i,j}, k_{i,j}, w_{i,j}) out of the multiplication triples and an interpolation wᵢ of the sent shares w_{i,j} of the products wᵢ=aᵢ·kᵢ of the random integers aᵢ, kᵢ by the plurality of signing devices 110.

In what follows, an honest-majority protocol for batch ECDSA signatures is described. The protocol is a threshold protocol for ECDSA, where multiple ECDSA private keys may be shared by n signing devices P₁, . . . , Pₙ, wherein n may be, for example, larger than 5. The signing devices 110 may run an interactive protocol to sign messages using the private keys.

In the execution of the threshold protocols, the signing devices P₁, . . . , Pₙ may communicate via a synchronous network, in which each pair of signing devices may be connected by a point-to-point secure channel, so a private and authenticated channel.

The number n may be taken to be n=2t+1; however, to a person skilled in the art it is clear that the protocols may be suitably adapted for any t, n satisfying the honest-majority case of t<n/2.

The key generation may be done in several ways, as discussed above. The n signing devices may hold shares of the private keys. The shares may be secret shares, e.g., Sharmir secret shares, e.g., (t+1)-out-of-n Shamir secret shares of the one or more private keys x⁽¹⁾, . . . , [symbol] . Signing device Pᵢ may hold the i th share

$${x}_{i}^{( 1 )} , … , {x}_{i}^{( ℓ )}$$

of each of the private keys.

A coordinating system, also called ‘coordinator’, may initiate a signing process among the n signing devices, as discussed above. The coordinating system may be distinct from the signing devices; however, any of the signing devices may play the role of the coordinator in any execution, and/or there could be multiple coordinators, including the case where there may be a different coordinator for each public key. When a coordinator may initiate execution of the protocol to sign a message using the i th private key, the coordinator may know the corresponding i th public key.

The threshold ECDSA protocol may be designed to have a presigning phase, or preprocessing phase, for batch generation of presignatures. Following the presigning phase, signing may be done non-interactively using one of those presignatures when a message to be signed is known.

The coordinator may initiate execution of the different phases of the protocol, e.g., the presigning phase and/or the signing phase.

To initiate computation of m presignatures, the coordinator may send a message, e.g., (presign, m) to one or more of the n signing devices. For example, the coordinator may send a message to initiate computation of presignatures to each of the signing devices.

In response, the signing devices may execute a protocol at the end of which (if the execution is not aborted) they each may output a collection of m presignatures.

To initiate computation of a signature on a hashed message h to be signed using the private key associated with public key y, the coordinator may send to each signing device Pⱼ an index indicating which presignature to use, the hashed message h, and an index identifying which key share to use.

The construction of signing protocols as presented here is described in a modular fashion. In what follows, a general framework for constructing an honest-majority threshold ECDSA protocol is presented. The framework is based on a functionality for

$${ℱ}_{rss}^{t , n}$$

for random secret sharing, and a functionality

$${ℱ}_{triple}^{t , n}$$

for generating multiplication triples, e.g., Beaver multiplication triples. The functionality

$${ℱ}_{triple}^{t , n}$$

may in turn be based on

$${ℱ}_{rss}^{t , n} .$$

Also, a functionality

$${ℱ}_{wmult}^{t , n}$$

may be realized for performing so-called weak multiplication of shared values. A protocol for

$${ℱ}_{triple}^{t , n}$$

may involve a batch verification check of multiplication triples.

These functionalities may be implemented in part using known techniques, and in part by novel protocols set out herein. For example, the functionality

$${ℱ}_{rss}^{t , n}$$

may be realized using existing techniques for pseudorandom secret sharing. In an embodiment, an implementation of

$${ℱ}_{rss}^{t , n}$$

is shown allowing a setting without broadcast or trusted setup, e.g., via allowing the signing devices to set up the shared keys themselves, without a dealer, and without any additional rounds for commitments or complaint resolution and without a broadcast channel.

In the following notation, [symbol] denotes a group of prime order q, with generator g. The field with q elements is denoted by [symbol] _{q}, and [symbol] denotes [symbol] _{q}\ {0}. Further, [n]={1, . . . , n} and κ denotes a computational security parameter. Lastly, s←S denotes a uniform selection of s from a finite set S.

Each j of the plurality of signing devices 110 in system 100 may be further configured to, during the computing of the one or more presignatures 115, generate a message g^{k}^{_{i,j}} corresponding to a share k_{i,j} of an integer kᵢ, using a generator g of the group, and send the generated message g^{k}^{_{i,j}} to another signing device 110 out of the plurality of signing devices 110. Each j of the plurality of signing devices 110 in system 100 may further be configured to generate a share k′_{i,j} of an inverse of the random integer kᵢ, and store the generated share

$${k}_{i , j}^{′}$$

of the inverse of the random integer kᵢ as part of the one or more presignatures 115.

Furthermore, each of the plurality of signing devices 110 in system 100 may further be configured to, during the computing of the one or more presignatures 115, generate one or more multiplication triples, wherein each of the one or more multiplication triples may comprise shares of one or more random integers. Each of the plurality of signing devices 110 in system 100 may further be configured to generate a share of an inverse of a random integer from one or more of the multiplication triples. Each (a_{i,j}, k_{i,j}, w_{i,j}) of the multiplication triples comprises shares (a_{i,j}, k_{i,j}) of integers (aᵢ, kᵢ), as well as a share (w_{i,j}) of the product (wᵢ=aᵢ·kᵢ) of the integers (aᵢ, kᵢ).

Furthermore, each j of the plurality of signing devices 110 may be further configured to send the share w_{i,j} of the product wᵢ=aᵢ·kᵢ of the random integers aᵢ, kᵢ to one or more other signing devices (140) out of the plurality of signing devices (110). Each j of the plurality of signing devices 110 may be further configured to generate a share

$${k}_{i , j}^{′} = {W}_{i}^{- 1} \cdot {a}_{i , j}$$

of the inverse of the random integer kᵢ corresponding to a multiplication triple (a_{i,j}, k_{i,j}, w_{i,j}) out of the multiplication triples and an interpolation wᵢ of the sent shares w_{i,j} of the products wᵢ=aᵢ·kᵢ of the random integers aᵢ, kᵢ by the plurality of signing devices 110.

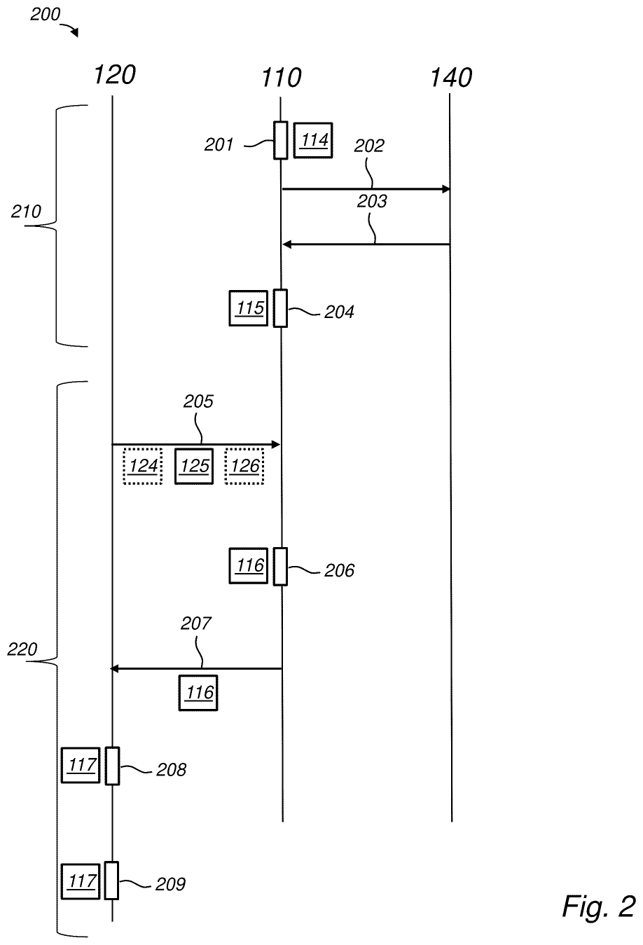

FIG. 2 schematically shows an example of a sequence diagram 200 for a system for presignature and signature generation. FIG. 2 shows a signing device 110 and a coordinating system 120, and one or more signing devices 140 which may be different from signing device 110. For example, these devices and systems could be as described with reference to FIGS. 1a-1f. Signing devices 110 and 140 and coordinating system 120 may be configured to communicate with each other over an authenticated channel, such as HTTPS, and, optionally, also a confidential channel. The system thus includes a plurality of signing devices, including signing device 110 and 140.

The system manages multiple private keys, while it is avoided that any one of the signing devices has access to a full private key. Accordingly, each of the plurality of signing devices stores a share of each of multiple private keys. For example, each private key may be divided into multiple shares, equal to the number of signing devices, and one different share of each private key may be stored at each signing device. There are various ways to do this. For example, a private key may be taken as input by a trusted dealer who generates secret shares and sends each share to a respective signing device. Or, the multiple private key shares may result from a distributed key generation protocol executed by the signing devices themselves.

Each of the plurality of signing devices is configured to communicate with one or more of the plurality of signing devices, possibly through a communicating channel.

Sequence diagram 200 comprises a presigning phase 210 and a signing phase 220. In an embodiment, signing device 110 may be configured to, in presigning phase 210, perform computations 114 in an action 201 of performing computations. Computations 114 may result in one or more presignatures 115. Part of computations 114 may comprise a result which may be shared by signing device 110 with other signing device 140, e.g., via a communicating channel, which may be configured to receive the result from signing device 110. The result may comprise presignature 115. In a message 202 signing device 110 may share the result of computations 114 with signing device 140 The other signing device 140 may be configured to receive the result from signing device 110. In an analogous manner, signing device 140 may share a result from the computations signing device 140 performs with signing device 110 in a message 203. Signing device 110 may be configured to locally store one or more presignature 115 which may result from the computations 114.

For example, in an embodiment, during the presigning phase 210, one or more presignatures 115 are computed. The presignatures are independent of the multiple private keys. This is advantageous, since it allows precomputation to be done before it is known for which of the multiple private keys a signature needs to be computed.

In an embodiment, a presignature corresponds to a pair of integers:

$${k}_{i}^{- 1}$$

and F (g^{k}^{ᵢ}), wherein F is a function that depends on the exact signature scheme used. The computations are performed in a finite ring, e.g., the integers modulo a modulus, e.g., a prime modulus.

For example, the plurality of signing devices, e.g., device 110 and 140, may together generate g^{k}^{ᵢ} corresponding to an integer kᵢ, using a generator g of the multiplicative group. Here i runs over the number of presignatures that are being generated. The integer kᵢ is not known to the signing devices; instead, each signing device may have a share k_{i,j} of the integer kᵢ. Here j is an integer that runs over the signing devices. For example, device j has the shares k_{i,j} for all i.

For example, the signing devices may share the message g^{k}^{_{i,j}} to the other signing devices, from which the value g^{k}^{ᵢ}, and subsequently, F(g^{k}^{ᵢ}), may be computed.

The signing devices further precompute a share

$${k}_{i , j}^{′}$$

or an inverse or the random integer kᵢ. The signing device may store as part of a presignature at least the generated share

$${k}_{i , j}^{′}$$

of the inverse of the random Integer kᵢ and F(g^{k}^{ᵢ}).

In other words, for each presignature an integer k becomes available at the signing devices in two ways, blinded in two different ways, as g^{k} and as one share of k⁻¹; both are insufficient to recover the number k. But they can be used as a precomputation for computing a signature. Note that neither integer depends on any of the private keys.

To generate shares of the inverse of kᵢ, without access to kᵢ, an interesting trick may be employed. The signing devices perform a protocol to jointly generate one or more multiplication triples, e.g., one multiplication triple for each presignature. A multiplication triple comprises three integers, one of which is the multiplication of the other two; however, the signing devices only obtain a share of each of the three integers in a multiplication triple.

Using a multiplication triple, a share of an inverse of a shared integer can be computed.

For example, a multiplication triple may comprise random integers (aᵢ, kᵢ, wᵢ) wherein wᵢ=aᵢ·kᵢ. The signing devices receive a share of each of these numbers: integers (a_{i,j}, k_{i,j}, w_{i,j}), wherein j identifies the signing device and i is an index in the precomputed presignatures.

The presignature devices can now proceed as follows:
send the share w_{i,j} of the product (wᵢ=aᵢ·kᵢ) of the random integers (aᵢ, kᵢ) to one or more other signing devices 140 out of the plurality of signing devices, and
generate a share

$${k}_{i , j}^{′} = {W}_{i}^{- 1} \cdot {a}_{i , j}$$

of the inverse of the random integer kᵢ corresponding to a multiplication triple (a_{i,j}, k_{i,j}, w_{i,j}) out of the multiplication triples and an interpolation wᵢ of the sent shares w_{i,j} of the products wᵢ=aᵢ·kᵢ of the random integers aᵢ, kᵢ by the plurality of signing devices.

The devices can further compute Rᵢⱼ=^{k}^{_{i,j}} and send this to the other signing devices. From this each signing device can compute Rᵢ=g^{k}^{ᵢ}. If desired, one can further precompute rᵢ=F(Rᵢ).

Various protocols exist for shared generating of multiplication triples, though below a particular advantageous protocol is described.

In an embodiment, in presigning phase 210 the signing device further computes for each presignature shares of a zero value. The zero value is useful for blinding during the signing phase, and may be stored as part of the presignature. Various protocols exist for shared generation of shares of zero, though below a particular advantageous protocol is described.

The generated presignature is stored locally at the signing device.

In signing phase 220, coordinating system 120 may be configured to send a selection for a private key out of the multiple private keys, and optionally a message to be signed and/or a selection for a presignature, in a message 205. In response, signing device 110 may be configured to generate a share 116 of a signature 117 in an action 206 of generating share 116 of signature 117. Signing device 110 may be configured to send generated share 116 of signature 117 in a message 207 of sending generated share 116 of signature 117. In response, coordinating system 120 may be configured to receive generated share 116 of signature 117 from signing device 110. Coordinating system 120 may be configured to combine generated shares 116 of signature 117 into signature 117 in an action 208 of combining generated shares 116 of signature 117 into signature 117. Coordinating may further optionally be configured to verify signature 117 using a public key in an action 209 of verifying signature 117.

For example, in an embodiment, during signing phase 220. The coordinating system 120 may send 205 the selection 125 for a private key to one or more of the plurality of signing devices. Coordinating system 120 may send the selection for a private key to each of the plurality of signing devices. Typically, coordinating system 120 will additionally send 205 to the plurality of signing devices the message 124 to be signed, typically in the form of a hash value. It is also possible that the signing devices receive the message to be signed from another source.

Note that during generation of the presignatures this information is not needed since each presignature can be used for any one of the private keys. The signing devices may be configured to use a predetermined one of the available presignatures. For example, the presignatures may be stored in order, and all of the signing devices may take the next available one. This reduces communication overhead between the devices. Alternatively, coordinating system 120 may be configured to additionally send 205 to the plurality of signing devices a selection 126 for a presignature 115 out of the one or more presignatures 115. For example, the presignatures may be saved together with an identifier. The identifier may be shared with the coordinating device.

The signing devices use the presignature and the hash to generate 206 a share 116 of a signature 117 for a message 124, using a presignature 115 out of the one or more presignatures computed 201 and stored 204 in the presigning phase 210. The generated shares 116 are sent to the coordinating system 120, which can then reconstruct the signature from them. The shares generated by the signing device may include, e.g., additively, a share of zero, to further obfuscate the information. Such an addition has no impact on the final signature.

A signing device preferably securely erases a presignature after using it to generate a signature share. Secure erasing does not allow un-deleting of the information.

After combining 208 the generated shares 116 of the signature 117 for the message 124 into the signature 117 for the message 124. Signature 117 is verified 209, e.g., by the coordinating device, using a public key 143 out of the at least one public key 143 corresponding to the selected private key 125 of the multiple private keys. The public keys may be stored at the coordination device or retrieved from a key library.

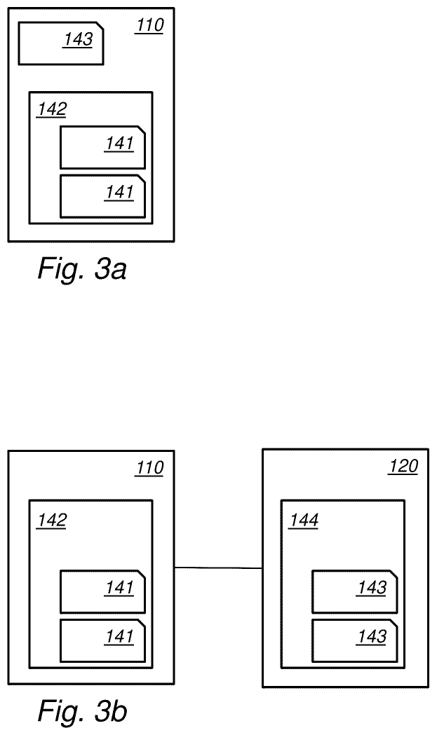

FIG. 3a schematically shows an example of an embodiment of a signing device 110 with a key storage 142, e.g., in secure hardware. Key storage 142 may store private key shares 141. Private key shares 141 may be associated with an asymmetric key pair, where the asymmetric key pair may comprise a private key and a public key 143.

FIG. 3b schematically shows an example of an embodiment of a signing device 110 which is connected to a coordinating system 120 with a key storage 144. Key storage 144 may store public keys 143 associated to private key shares 141. Signing device 110 may be configured to connect to coordinating system 120 via communication interface 113.

Below various further embodiments are discussed. In particular, an honest-majority threshold signing protocol is described, supporting batch generation of presignatures, in particular supporting ECDSA. Embodiments support multiple signing devices, each holding shares of multiple private keys. Furthermore, batch presignature generation is supported, in which signing devices simultaneously generate a number of presignatures at better amortized cost. It is an aim that the presignatures generated by those signing devices to be usable for any one of those keys.

Notation. [symbol] is a group of prime order q, with generator g. The field with q elements is denoted by [symbol] _{q}, and [symbol] = [symbol] _{q}\{0}. We let [n]={1, . . . , n}, and let κ be a computational security parameter. We let s←S denote uniform selection of s from finite set S.

Lagrange interpolation. If ƒ∈ [symbol] _{q}[X] is a polynomial of degree at most t, then it is determined by its values on any t+1 distinct points. Thus, for any j∈ [symbol] _{q} and S⊂ [symbol] _{q} of size t+1, there are efficiently computable Lagrange coefficients

$${\{ {λ}_{i , j}^{s} \}}_{i ∈ S}$$

such that

$$f ( j ) = {\sum }_{i ∈ S} {λ}_{i , j}^{s} \cdot f ( i ) .$$

For any S⊂ [symbol] _{q} of size t+1 and any {yᵢ}_{i∈S} with yᵢ∈ [symbol] _{q}, we let interpolateₜ

$$( j , S , {\{ {y}_{i} \}}_{i ∈ S} ) = {\sum }_{i ∈ S} {λ}_{i , j}^{S} \cdot {y}_{i} .$$

When |S|≥t+1, we can verify whether values {yᵢ}_{i∈S} (with yᵢ∈ [symbol] _{q}) are consistent with a degree-t polynomial ƒ (e.g., whether there exists a polynomial ƒ of degree at most t such that ƒ(i)=yᵢ for all i∈S) by letting S′⊆S be an arbitrary subset of size t+1 and checking that yⱼ [symbol] interpolateₜ(j, S′, {yᵢ}_{i∈S}) for all j∈S\s′. Overloading notation, for |S|≥t+1 we let interpolateₜ(j, S, {yᵢ}_{i∈S}) be the function that returns ⊥ if the {yᵢ}_{i∈S} are not consistent with a degree-t polynomial, and otherwise returns interpolateₜ(j, S′, {yᵢ}_{i∈S′}) (for an arbitrary S′⊆S of size t+1). (Note that when |S|=t+1, any values {yᵢ}_{i∈S} are consistent.)

We further overload notation by allowing for interpolation “in the exponent.” That is, for S⊂ [symbol] _{q}, of size t+1 and any {gᵢ}_{i∈S} with gᵢ∈ [symbol] , we let interpolateₜ

$$( j , S , {\{ {g}_{i} \}}_{i ∈ S} ) = {\sum }_{i ∈ S} {g}_{i}^{{λ}_{i , j}^{S}} .$$

Note that if we let xᵢ=log_{g}gᵢ for all i, then log_{g}interpolateₜ(j, S, {gᵢ}_{i∈S})=interpolateₜ(j, S, {xᵢ}_{i∈S}). For |S|≥t+1, we can verify whether values {gᵢ}_{i∈S} are consistent with a degree-t polynomial in the natural way, and define interpolateₜ(j, S, {gᵢ}_{i∈S}) in a manner exactly analogous to above.

Shamir secret sharing. The (t+1)-out-of-n Shamir secret sharing of a value x∈ [symbol] _{q} works by setting a₀:=x, choosing a₁, . . . , aₜ← [symbol] _{q}, defining the polynomial

$$f ( X ) = {\sum }_{i = 0}^{t} {a}_{i} {X}^{i} ∈ {ℤ}_{q} [ X ]$$

of degree at most t, and outputting the shares x₁=ƒ(1), . . . , xₙ=ƒ(n). We denote this by (x₁, . . . , xₙ)←SSₜ(x). The value of ƒ at any point can be derived from any set of t+1 of the shares using Lagrange interpolation; in particular, this allows for reconstructing the secret x=ƒ(0) from any t+1 shares.

ECDSA. For our purposes, the ECDSA signature scheme works as follows. To sign a hashed message h∈ [symbol] _{q} with private key x∈ [symbol] _{q}, the signer chooses k← [symbol] *_{q}, sets R:=g^{k}, and computes r:=F(R)∈ [symbol] _{q} for a publicly known function F. It then computes s:=k⁻¹·(h+rx) mod q and, if s>q/2, sets s:=q−s. Note we preferably signature normalization is done to prevent malleability attacks. It outputs the signature (r,s). Signature (r, s) on hashed message h with respect to public key y is verified by checking that 0<s<q/2 and F (g^{h·s}^{^{−1}}·y^{r·s}^{^{−1}})=r. We denote such signature verification by Vrfy_{y}(h,(r,s)).

Multiple ECDSA private keys may be shared by n signing devices P₁, . . . , Pₙ. The signing devices 110 may run an interactive protocol to sign messages using the private keys. An adversary, who may corrupt up to t<n/2 of the signing devices, should be unable to forge a signature under any key on any other message. For ease of exposition, we may let [symbol] ⊂[n] denote the indices of the corrupted signing devices, and let [symbol] =[n]\ [symbol] be the indices of the honest signing devices; although of course the identity of the honest and corrupted signing devices are not known in a real implementation

In the execution of the threshold protocols, the signing devices P₁, . . . , Pₙ, may communicate via a synchronous network, in which each pair of signing devices may be connected by a point-to-point secure channel, so a private and authenticated channel.

The number n may be taken to be n=2t+1; however, to a person skilled in the art it may be clear that the protocols may be suitably adapted for any t, n satisfying the honest-majority case of t<n/2.

The key generation may be done in several ways, as discussed above. The n signing devices may hold shares of the private keys. The shares may be secret shares, e.g., Sharmir secret shares, e.g., (t+1)-out-of-n Shamir secret shares of the one or more private keys x⁽¹⁾, . . . , [symbol] . Signing device Pᵢ may hold the i th share

$${x}_{i}^{( 1 )} , … , {x}_{i}^{( ℓ )}$$

of each of the private keys.

A coordinating system, also called ‘coordinator’, may initiate a signing process among the n signing devices, as discussed above. The coordinator may be distinct from the signing devices; however, any of the signing devices may play the role of the coordinator in any execution, and/or there could be multiple coordinators, including the case where there may be a different coordinator for each public key. When a coordinator may initiate execution of the protocol to sign a message using the i th private key, the coordinator may know the corresponding i th public key.

The threshold ECDSA protocol may be designed to have a presigning phase, or preprocessing phase, for batch generation of presignatures. Following the presigning phase, signing may be done non-interactively using one of those presignatures when a message to be signed is known. It may be chosen to use each presignature only once, e.g., for security reasons.

The coordinator may initiate execution of the different phases of the protocol, e.g., the presigning phase and/or the signing phase.

To initiate computation of m presignatures, the coordinator may send a message, e.g., (presign, m) to one or more of the n signing devices. For example, the coordinator may send the message to each of the n signing devices.

In response, the signing devices may execute a protocol at the end of which (if the execution is not aborted) they each may output a collection of m tuples.

To initiate computation of a signature on a hashed message h to be signed using the private key associated with public key y, the coordinator may send to one or more of the signing devices Pⱼ, for example, to each of the signing devices, an index indicating which presignature to use, the hashed message h, and an index identifying which key share to use. It may be chosen to provide one or more signing devices, for example, to each of the signing devices, with the corresponding key share as input, instead of an index identifying which key share to use.

Whenever the signing devices may execute the described signing protocol, they may each hold the same hashed message h, use key shares for the private key associated with public key y (thus, the key shares used by the signing devices to form a valid (t+1)-out-of-n sharing of log_{g} h, use the same presignature, and never reuse a presignature. The semi-honest coordinator as described above may enforce all of these aspects.

Below is a description of protocol

$${\prod }_{ECDSA}^{t , n} .$$

The protocol uses protocol

$${ℱ}_{rss}^{t , n} and {ℱ}_{triple}^{t , n} .$$

$${ℱ}_{rss}^{t , n}$$

is a protocol for random secret sharing with the following functionality.

Init: On input init from at least one signing device, and optionally from a majority of the signing devices, send initialized to all signing devices. Each of the following can then be called at most once.

Rand: On input (rand, m) send a share {r_{i,j}}_{i∈[m]} to Pⱼ of a random number to at least a majority of the signing devices.

Zero: On input (zero, m) send {o_{i,j}}_{i∈[m]} to Pⱼ of zero to at least a majority of the signing devices.

$${ℱ}_{triple}^{t , n}$$

is a protocol for batch generation of multiplication triples with the following functionality.

Receive (triple, m) from a signing device, or from at least a majority of the signing devices send {(a_{i,j}, k_{i,j}, w_{i,j})}_{i∈[m]} to Pⱼ. Wherein the a_{i,j}, k_{i,j}, w_{i,j} are shares of integers aᵢ, kᵢ, wᵢ, with aᵢkᵢ=wᵢ.

Various protocols for the generation of multiplication triples are known, e.g., Beaver triples.

Π_{ECDSA}^{t,n}. General framework for computing ECDSA signatures.

Presigning: On input (presign, m), each signing device Pⱼ does:
1. Send init to

$${ℱ}_{rss}^{t , n} .$$

2. Call

$${ℱ}_{rss}^{t , n}$$

on input (zero, m), and let {o_{i,j}}_{i∈[m]} be the result.
3. Call

$${ℱ}_{triple}^{t , n}$$

on input (triple, m). If the result is abort then abort; otherwise, let {(a_{i,j}, k_{i,j}, w_{i,j})}_{i∈[m]} be the result.
4. For i∈[m], send w_{i,j} and R_{i,j}:=g^{k}^{_{i,j}} to all other signing devices.
5. Let wᵢ:=interpolateₜ(0, [n], {w_{i,j}}_{j∈[n]}) and Rᵢ:=interpolateₜ(0, [n], {R_{i,j}}_{j∈[n]}) for all i∈[m]. If wᵢ∈{⊥,0} or Rᵢ=⊥ for some i, abort. Otherwise, for i∈[m] set

$${k}_{i , j}^{′} := {w}_{i}^{- 1} \cdot {a}_{i , j}$$

and rᵢ:=F(Rᵢ). Store the tuples {(rᵢ, o_{i,j}, k′_{i,j})}_{i∈[m]} and send completed to the coordinator.

If the coordinator receives completed from all signing devices, it outputs completed; otherwise it outputs abort. Note that in step 4 communication can be reduced at the expense of an additional round by having each Pⱼ send w_{i,j}, R_{i,j} to a designated device, who then reconstructs wᵢ, Rᵢ and sends those values to all signing devices. This affects the security proofs only slightly.

Signing: On input (sign, i, h, xⱼ), each signing device Pⱼ does:
1. Set sⱼ:=k′_{i,j}·(h+rᵢ·xⱼ)+o_{i,j}. Send (rᵢ, sⱼ) to the coordinator. Delete (rᵢ, o_{i,j}, k′_{i,j}).

The coordinator, who holds input (sign, i, h, y), then does:
1. Let {(rⱼ, sⱼ)}_{j∈[n]} be the messages received. If some signing device sends nothing, output abort. Let r:=r₁. If rⱼ≠r₁ for some j, output abort.
2. Set s:=interpolate₂ₜ(0, [n], {s_{i,j}}_{j∈[n]}); if s>q/2, set s:=q−s. If Vrfy_{y}(h,(r,s))≠1, output abort; else output (r,s).

It can be mathematically proven that for any t<n/2, protocol

$${Π}_{ECDSA}^{t , n}$$

t-securely realizes reactive functionality

$${ℱ}_{ECDSA}^{t , n}$$

in the

$$\{ {ℱ}_{rss}^{t , n} , {ℱ}_{triple}^{t , n} \}$$

hybrid model.

The functionality

$${ℱ}_{triple}^{t , n}$$

may be based on

$${ℱ}_{rss}^{t , n} .$$

Also, a functionality

$${ℱ}_{wmult}^{t , n}$$

may be realized for performing weak multiplication of shared values. A protocol for

$${ℱ}_{triple}^{t , n}$$

may involve a batch verification check of multiplication triples, e.g., random multiplication triples, which may be based on known work, which is optimized, e.g., made more efficient, for the current setting. The functionality

$${ℱ}_{rss}^{t , n}$$

may be realized using existing techniques for pseudorandom secret sharing, which may also be optimized for a setting without broadcast or trusted setup, e.g., via allowing the signing devices to set up the shared keys themselves, without a dealer, and without any additional rounds for commitments or complaint resolution and without a broadcast channel. The functionality

$${ℱ}_{wmult}^{t , n}$$

may be realized using standard techniques.

Realizing

$${ℱ}_{triple}^{t , n}$$

Below a possible embodiment of

$${ℱ}_{triple}^{t , n}$$

is provided. In the construction signing devices multiply a number of secret-shared values using a weak multiplication subroutine that preserves privacy of inputs and outputs but allows the adversary to introduce an arbitrary additive shift in the result. For example, see functionality

$${ℱ}_{wmult}^{t , n} .$$

The signing devices additionally share a random value r, and for each multiplication of shared values a, b to give output ab they also compute shares of ra, rb, and rab using the same weak multiplication protocol. At the end of the computation, the signing devices perform a probabilistic check using m fresh random values to verify that the adversary has not introduced an additive shift in any of the multiplications.

In the context of ECDSA it suffices to securely generate multiplication triples during a preprocessing phase. We observe that it is enough to generate 2m+2 random values and perform 3m weak multiplications. To generate m multiplication triples with conventional methods would involve generating 3m+1 random values and performing 4m weak multiplications.

$${ℱ}_{wmult}^{t , n}$$

Functionality for (weak) multiplication secure up to additive attacks.

Receive {(a_{i,j}, k_{i,j})}_{i∈[m]} from the signing devices. For i∈[m] send {w_{i,j}}_{i∈[m]} to Pⱼ, wherein the corresponding integers aᵢ, kᵢ, wᵢ form a multiplication triple.

The protocol

$${\prod }_{triple}^{t , n}$$

for realizing

$${ℱ}_{triple}^{t , n}$$

based on

$${ℱ}_{wmult}^{t , n} . {ℱ}_{wmult}^{t , n}$$

can be realized using standard techniques. Before turning to the full proof of security for protocol

$${\prod }_{triple}^{t , n} ,$$

we provide some intuition. In the protocol, signing devices first generate shares of uniform values {aᵢ}_{i∈[m]}, {kᵢ}_{i∈[m]}, and r, β, where aᵢ=interpolateₜ(0, [symbol] , {a_{i, j}} [symbol] ) and kᵢ, r, and β are defined similarly. They then use

$${ℱ}_{wmult}^{t , n}$$

to compute shares of {wᵢ}_{i∈[m]} (where wᵢ is supposed to equal kᵢ·aᵢ), {μᵢ}_{i∈[m]} (where μᵢ is supposed to equal r·aᵢ), and {τᵢ}_{i∈[m]} (where τᵢ is supposed to equal μᵢ·kᵢ). Finally, they reconstruct r and β, and publicly reveal

$$T = {\sum }_{i = 1}^{m} ( {τ}_{i} - r {w}_{i} ) \cdot {β}^{i} .$$

If all signing devices behave honestly, then τᵢ=raᵢ·kᵢ=rwᵢ for all i and so T=0. The more interesting case is when the adversary exploits the weak multiplication functionality to give incorrect output by using a nonzero shift.

$${\prod }_{triple}^{t , n}$$

### Realizing

$${ℱ}_{triple}^{t , n}$$

in the

$$\{ {ℱ}_{rss}^{t , n} , {F}_{wmult}^{t , n} \} .$$

hybrid model.

On input (triple, m), each signing device Pⱼ does:
1. Send init to

$${ℱ}_{rss}^{t , n} .$$

2. Call

$${ℱ}_{rss}^{t , n}$$

on input (rand,2m+2). Denote the first 2m results {a_{i,j}}_{i∈[m]} and {k_{i,j}}_{i∈[m]}, and the final two results by rⱼ, βⱼ.
3. Call

$${ℱ}_{wmult}^{t , n}$$

with inputs {(k_{i,j}, a_{i,j})}_{i∈[m]} and {(rⱼ, a_{i,j})}_{i∈[m]}. If the result is abort, abort; else, let {w_{i,j}}_{i∈[m]} and {μ_{i,j}}_{i∈[m]}, respectively, be the results.
4. Call

$${ℱ}_{wmult}^{t , n}$$

with inputs {(μ_{i,j},k_{i,j})}_{i∈[m]}. If the result is abort, abort; else, let {τ_{i,j}}_{i∈[m]} be the result.
5. Send rⱼ, βⱼ to all signing devices. If some signing device does not send a value, abort; else, let r:=interpolateₜ(0, [n], {βⱼ}_{j∈[n]}) and β:=interpolateₜ(0, [n], {βⱼ}_{j∈[n]}). If r=⊥ or β=⊥, abort.
6. Compute

$${T}_{j} = {\sum }_{i = 1}^{m}$$

(τ_{i,j}−r·w_{i,j})·βⁱ anu send it to all signing devices. If some signing device does not send a value, abort; else, let T:=interpolateₜ(0, [n], {Tⱼ}_{j∈[n]}). If T≠0, abort; otherwise, output {(a_{i,j}, k_{i,j},w_{i,j})}_{i∈[m]}.

It can mathematically be proven that for any t<n/2, protocol

$$\{ {ℱ}_{rss}^{t , n} , {ℱ}_{wmult}^{t , n} \}$$

t-securely realizes correct functionality

$${\prod }_{triple}^{t , n}$$

in the

$${ℱ}_{triple}^{t , n}$$

hybrid model.

### Pseudorandom Secret Sharing

To realize [symbol] _{rand} and [symbol] _{zero}, it is possible to rely on pseudorandom secret sharing (PRSS). We begin by describing how to realize [symbol] _{rand}. For t≤n, let [symbol] _{n-t,n} denote the collection of all subsets of [n] of size n−t. For A∈ [symbol] _{n-t,n}, let ƒ_{A}∈ [symbol] _{q}[X] be the polynomial of degree at most t such that

$${f}_{A} ( x ) = \{ \begin{matrix}1 & x = 0 \\ 0 & x ∈ [ n ] \backslash A .\end{matrix}$$

Let Ψ:{0,1}^{κ}×{0,1}*→ [symbol] _{q}, be a pseudorandom function. Assume there are keys {k_{A}} [symbol] such that each signing device Pᵢ holds {k_{A}}_{i∈A}. Then signing devices can non-interactively generate a (t+1)-out-of-n sharing of a secret indexed by a by having each Pᵢ compute the share

$${σ}_{i}^{α} := {\sum }_{A ∈ {𝕊}_{n - t , n} : i ∈ A} {Ψ}_{{k}_{A}} ( α ) \cdot {f}_{A} ( i ) .$$

To see that this gives a valid (t+1)-out-of-n Shamir sharing, define the polynomial

$$α ( X ) = {\sum }_{A ∈ {𝕊}_{n - t , n}} {Ψ}_{{k}_{A}} ( α ) \cdot {f}_{A} ( X )$$

that has degree at most t. Then observe that for i∈[n] it holds that

$$α ( i ) = {\sum }_{A ∈ {𝕊}_{n - t , n}} {Ψ}_{{k}_{A}} ( α ) \cdot {f}_{A} ( i ) = {\sum }_{A ∈ {𝕊}_{n - t , n} : i ∈ A} {Ψ}_{{k}_{A}} ( α ) \cdot {f}_{A} ( i ) = {σ}_{i}^{α} .$$

The value defined by these shares is

$$α ( 0 ) = {\sum }_{A ∈ {𝕊}_{n - t , n}} {Ψ}_{{k}_{A}} ( α ) \cdot {f}_{A} ( 0 ) = {\sum }_{A ∈ {𝕊}_{n - t , n}} {Ψ}_{{k}_{A}} ( α ) .$$

If k_{H} is uniform and independent of the other keys, then for any set [symbol] of t corrupted signing devices and any distinct values α₁, . . . , the shared values α₁(0), . . . are jointly pseudorandom, even conditioned on the view of the corrupted signing devices. We remark that this holds regardless of how the [symbol] are chosen (so long as [symbol] is independent of the other keys).

This can be extended to generate a random (2t+1)-out-of-n sharing of 0, something referred to as pseudorandom zero sharing (PRZS). Assume keys [symbol] distributed as before. Now, a signing device Pᵢ can compute a 0-sharing indexed by β as

$${σ}_{i}^{β} = {{\sum }_{A ∈ {𝕊}_{n - t , n}}}_{i ∈ A} {\sum }_{j = 1}^{t} {Ψ}_{{k}_{A}} ( β \vert \vert j ) \cdot {i}^{j} \cdot {f}_{A} ( i )$$

(where “∥” denotes concatenation). These shares correspond to points on the polynomial

$$β ( X ) = {\sum }_{A ∈ {𝕊}_{n - t , n}} {\sum }_{j = 1}^{t} {Ψ}_{{k}_{A}} ( β \vert \vert j ) \cdot {X}^{j} \cdot {f}_{A} ( X ) ,$$

which has degree at most 2t and satisfies β(0)=0. If [symbol] is uniform and independent of the other keys as above, it can be verified that (even given the view of an adversary corrupting up to t signing devices) the shares

$${\{ {σ}_{i}^{β} \}}_{i ∈ ℋ}$$

are uniform subject to the constraint that interpolateₜ

$$( 0 , [ n ] , {\{ {σ}_{i}^{β} \}}_{i ∈ [ n ]} ) = 0.$$

In prior work on PRSS/PRZS, it is assumed that a trusted dealer chooses keys and distributes them to the appropriate signing devices, or else a complex protocol is run to securely establish those keys. We observe that neither of these are necessary, and it suffices to have a designated device

$${P}_{A}^{*}$$

for each set A∈ [symbol] _{n-t,n} (say,

$${P}_{A}^{*} - {P}_{i}$$

where i is the smallest index in A) choose a uniform key k_{A}∈{0,1}^{κ} and send it (via private channel) to each Pᵢ with i∈A. (If some Pᵢ, i∈A, does not receive anything from

$${P}_{A}^{*} ,$$

it sets k_{A} to a default value.) At a high level, this is still secure since
The key [symbol] will be chosen uniformly and independently of the other keys, shared correctly, among the honest signing devices, and unknown to the adversary.
For any set A∈ [symbol] _{n-t,n} that contains a corrupted signing device, the adversary anyway learns k_{A} even if a trusted dealer distributes keys.
If the designated device for some subset A is corrupted, that signing device can send different keys k_{A} to different signing devices in A. Nevertheless, for PRSS the shares computed by the honest signing devices are uniform and independent (even conditioned on the view of the adversary) and hence define some random shared value; for PRZS the shares computed by the honest signing devices are uniform and independent subject to a linear constraint (that depends on the view of the corrupted signing devices) as required by the functionality.

PRSS^{m,t,n} Protocol for pseudorandom secret sharing.

For every set A∈ [symbol] _{n-t,n} do:
(a) Let

$${P}_{A}^{*}$$

be a designated device with

$${P}_{A}^{*} ∈ {\{ {P}_{i} \}}_{i ∈ A} .$$

(b)

$${P}_{A}^{*}$$

chooses k_{A}←{0,1}^{κ} and sends k_{A} (via secure channel) to {Pᵢ}_{i∈A}.
(c) Each signing device Pⱼ lets

$${k}_{A}^{j}$$

be the key it received from

$${P}_{A}^{*}$$

### for set A. (If

$${P}_{A}^{*}$$

sends no value for k_{A}, the Pⱼ sets

$${k}_{A}^{j} := {0}^{κ} . )$$

On input (rand, m), each signing device Pⱼ does:
(a) For i∈[m], set

$${r}_{i , j} := {\sum }_{A ∈ {𝕊}_{n - t , n} : j ∈ A} {Ψ}_{{k}_{A}^{j}} ( 0 ‖ i ) \cdot {f}_{A} ( j ) .$$

(b) Output {r_{i,j}}_{i∈[m]}.

On input (zero, m), each signing device Pⱼ does:
(a) For i∈[m],set

$${o}_{i , j} := {\sum }_{A ∈ {S}_{n - t , n} : j ∈ A} {\sum }_{ℓ = 1}^{t} {Ψ}_{{k}_{A}^{j}} ( 1 ‖ i ‖ ℓ ) \cdot {j}^{ℓ} \cdot {f}_{A} ( j ) .$$

(b) Output {o_{i,j}}_{i∈[m]}.

As written, the protocol can be used for only one execution of Rand and one execution of Zero per invocation of Init. However, it is possible to rely on a single invocation of Init for arbitrarily many executions of Rand/Zero. For example, one may use domain separation for the underlying calls to the pseudorandom function Y. Within a single protocol this can be done use distinct identifiers for different calls to Rand/Zero; across executions this can be done by relying on a random session id that is assumed not to repeat. It can be mathematically proven that Y′ is a pseudorandom function, then protocol PRSS^{t,n} t-securely realizes

$${ℱ}_{rss}^{t , n} .$$

### Realizing Weak Multiplication

Here we show how to realize

$${ℱ}_{w mult}^{t , n}$$

based on

$${ℱ}_{rss}^{t , n} .$$

Note that a broadcast channel is not needed.

$${\prod }_{wmult}^{t , n}$$

### Realizing

$${ℱ}_{wmult}^{t , n}$$

in the

$${ℱ}_{rss}^{t , n}$$

hybrid model.

On input {(a_{i,j}, k_{i,j})}_{i∈[m]}, each signing device Pⱼ does:
1. Send init to

$${ℱ}_{rss}^{t , n} .$$

2. Call

$${ℱ}_{rss}^{t , n}$$

on input (rand, m). Denote the result by {r_{i,j}}_{i∈[m]}.
3. Call

$${ℱ}_{rss}^{t , n}$$

on input (zero, m). Denote the result by {o_{i,j}}_{i∈[m]}.
4. For i∈[m] compute e_{i,j}:=a_{i,j}·k_{i,j}+r_{i,j}+o_{i,j} and send e_{i,j} to all signing devices. If some signing device does not send a value, abort.
5. For i∈[m], compute eᵢ:=interpolateₜ(0, [n], {e_{i,j}}_{j∈[n]}) and output {w_{i,j}:=eᵢ−r_{i,j}}_{i∈[m]}.

It can be mathematically proven that protocol

$${\prod }_{wmult}^{t , n}$$

t-securely realizes

$${ℱ}_{wmult}^{t , n}$$

in the

$${ℱ}_{rss}^{t , n}$$

-hybrid model.

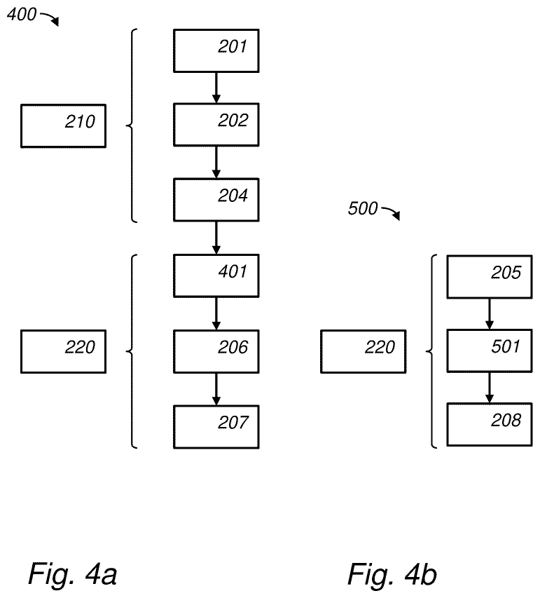

FIG. 4a schematically shows an example of an embodiment of a presignature and signature generation method 400 for a signing device 110 storing a share 141 of each of multiple private keys. Method 400 may comprise, in a presigning phase 210, a step 201 of computing one or more presignatures 115, independent of the multiple private keys. Method 400 may optionally comprise, in presigning phase 210, a step 202 of sharing a result of the computations 114 with one or more other signing devices 140. The result of the computations which may be shared may comprise the one or more presignatures 115. Method 400 may further comprise, in presigning phase 210, a step 204 of locally storing the one or more presignatures 115. Method 400 may further comprise, in a signing phase 220, a step 401 of receiving from a coordinating system 120 a selection 125 for a private key out of the multiple private keys. Method 400 may further comprise, in signing phase 220, a step 206 of generating a share 116 of a signature 117 for a message 124, using a presignature 115 out of the one or more presignatures 115 computed and stored in steps 201 and 204 of presigning phase 210. Method 400 may further comprise, in signing phase 220, a step 207 of sending the generated share 116 of signature 117 for message 124 to a coordinating system 120.

FIG. 4b schematically shows an example of an embodiment of a signature generation method 500 for a coordinating system 120. Method 500 may comprise, as part of a signing phase 220, a step 205 of sending a selection 125 for a private key out of multiple private keys to each of a plurality of signing devices 110. Method 500 may comprise, as part of a signing phase 220, a step 501 of receiving generated shares 116.1, 116.2, 116.3 of a signature 117 for a message 124 from one or more of the plurality of signing devices 110. Method 500 may comprise, as part of a signing phase 220, a step 208 of combining generated shares 116.1, 116.2, 116.3 of signature 117 for message 124 into the eventual signature 117.

Many different ways of executing method 400 and/or method 500 are possible, as will be apparent to a person skilled in the art. For example, the order of the steps can be performed in the shown order, but the order of the steps can be varied or some steps may be executed in parallel. Moreover, in between steps other method steps may be inserted. The inserted steps may represent refinements of method 400 and/or method 500 such as described herein, or may be unrelated to method 400 and/or method 500. For example, some steps may be executed, at least partially, in parallel. Moreover, a given step may not have finished completely before a next step is started.

Embodiments of method 400 and/or method 500 may be executed using software, which comprises instructions for causing a processor system to perform method 400 and/or method 500, or the steps taking place in phases 210 and/or 220 of method 400 and/or method 500. Software may only include those steps taken by a particular sub-entity of the system. The software may be stored in a suitable storage medium, such as a hard disk, a memory, an optical disc, etc. The software may be sent as a signal along a wire, or wireless, or using a data network, e.g., the Internet. The software may be made available for download and/or for remote usage on a server. Embodiments of method 400 and/or method 500 may be executed using a bitstream arranged to configure programmable logic, e.g., a field-programmable gate array, to perform method 400 and/or method 500.

It will be appreciated that the presently disclosed subject matter also extends to computer programs, particularly computer programs on or in a carrier, adapted for putting the presently disclosed subject matter into practice. The program may be in the form of source code, object code, a code intermediate source, and object code such as partially compiled form, or in any other form suitable for use in the implementation of an embodiment of the method. An embodiment relating to a computer program product comprises computer executable instructions corresponding to each of the processing steps of at least one of the methods 400 and/or 500 set forth. These instructions may be subdivided into subroutines and/or be stored in one or more files that may be linked statically or dynamically. Another embodiment relating to a computer program product comprises computer executable instructions corresponding to each of the devices, units, and/or parts of at least one of the systems and/or products set forth.

Method 400 and/or method 500 may be a computer-implemented method. For example, accessing and sharing the training data, and/or receiving other input data may be done using a communication interface, e.g., an electronic interface, a network interface, a memory interface, etc. For example, storing or retrieving training parameters may be done from an electronic storage, e.g., a memory, a hard drive, etc. For example, adjusting stored parameters may be done using an electronic computing device, e.g., a computer.

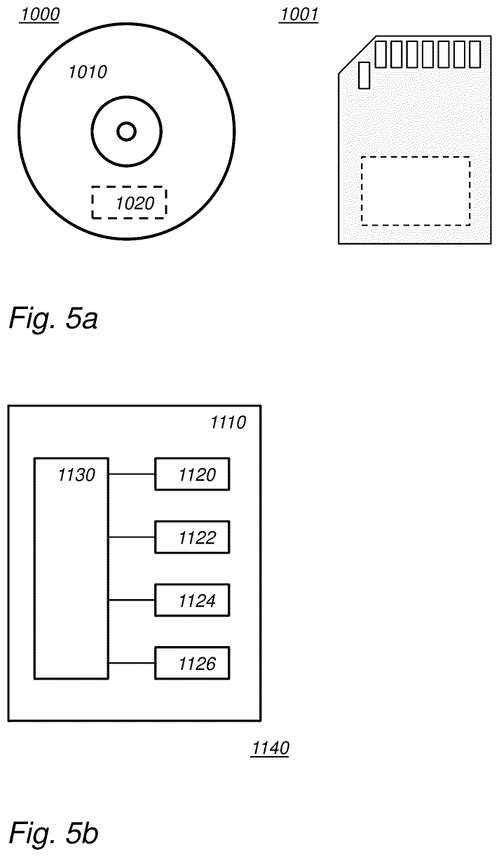

FIG. 5a schematically shows a computer readable medium 1000 having a writable part 1010, and a computer readable medium 1001 also having a writable part. Computer readable medium 1000 is shown in the form of an optically readable medium. Computer readable medium 1001 is shown in the form of an electronic memory, in this case a memory card. Computer readable medium 1000 and 1001 may store data 1020 wherein the data may indicate instructions, which when executed by a processor system, cause a processor system to perform an embodiment of method 400 and/or method 500. Computer readable medium 1000, 1001 may also be configured to store one or more presignatures 115 computed by a signing device 110, wherein signing device 110 may be configured to store a share 141 of each of multiple private keys, to compute the one or more presignatures 115 independent of the multiple private keys, and to locally store the one or more presignatures 115 on computer-readable medium 1000, 1001.

Data 1020 may comprise a computer program 1020 according to an embodiment, The computer program 1020 may be embodied on the computer readable medium 1000 as physical marks or by magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 may comprise instructions for causing a processor system to perform an embodiment of method 400 and/or method 500, or to store one or more presignatures 115 as discussed above.

FIG. 5b schematically shows a schematic representation of a processor system 1140 according to an embodiment. The processor system comprises one or more integrated circuits 1110. The architecture of the one or more integrated circuits 1110 is schematically shown. Circuit 1110 comprises a processing unit 1120, e.g., a CPU, for running computer program components to execute a method 700 according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1140 may be arranged for contact and/or contact-less communication, using an antenna and/or connectors, respectively.

For example, in an embodiment, processor system 1140 may comprise a processor circuit and a memory circuit, the processor being arranged to execute software stored in the memory circuit. For example, the processor circuit may be an Intel Core i7 processor, ARM Cortex-R8, etc. The memory circuit may be an ROM circuit, or a non-volatile memory, e.g., a flash memory. The memory circuit may be a volatile memory, e.g., an SRAM memory. In the latter case, the device may comprise a non-volatile software interface, e.g., a hard drive, a network interface, etc., arranged for providing the software.

While system 1140 is shown as including one of each described component, the various components may be duplicated in various embodiments. For example, the processing unit 1120 may include multiple microprocessors that are configured to independently execute the methods described herein or are configured to perform steps or subroutines of the methods described herein such that the multiple processors cooperate to achieve the functionality described herein. Further, where the system 1140 is implemented in a cloud computing system, the various hardware components may belong to separate physical systems. For example, the processor 1120 may include a first processor in a first server and a second processor in a second server.

The following numbered clauses represent advantageous embodiments.

Clause 1. A system (100) for presignature and signature generation, the system (100) comprising a plurality of signing devices (110) and a coordinating system (120), wherein each of the plurality of signing devices (110) stores a share (141) of each of multiple private keys, wherein
each of the plurality of signing devices (110) comprises one or more processors (111) and one or more storage devices (112) storing instructions that, when executed by the one or more processors (111), cause the one or more processors (111) to perform operations for
in a presigning phase (210),
computing (201) one or more presignatures (115), independent of the multiple private keys, and
locally storing (204) the one or more presignatures (115),

and
in a signing phase (220), upon receiving from the coordinating system (120) a selection (125) for a private key out of the multiple private keys,
generating (206) a share (116, 116.1, 116.2, 116.3) of a signature (117) for a message (124), using a presignature (115) out of the one or more presignatures (115) computed (201) and stored (204) in the presigning phase (210), and
sending (207) the generated share (116, 116.1, 116.2, 116.3) of the signature (117) for the message (124) to the coordinating system (120),

and
the coordinating system (120) comprises one or more processors (121) and one or more storage devices (122) storing instructions that, when executed by the one or more processors (121), cause the one or more processors (121) to perform operations for
sending (205) the selection (125) for a private key to one or more of the signing devices (110),
upon receiving the generated shares (116, 116.1, 116.2, 116.3) of the signature (117) for a message (124) from one or more of the signing devices (110), combining (208) the generated shares (116, 116.1, 116.2, 116.3) of the signature (117) for the message (124) into a signature (117).

For example, the coordinating system may send the selection (125) for a private key to each of the plurality of signing devices (110). For example, the coordinating system may receive the generated shares (116, 116.1, 116.2, 116.3) of the signature (117) for a message (124) from each of the plurality of signing devices (110).

Clause 2. A system (100) according to Clause 1, wherein each of the plurality of signing devices (110) is configured to, in the presigning phase (210), perform computations (114) resulting in a plurality of presignatures (115), each of the plurality of presignatures (115) being independent of the multiple private keys.

Clause 3. A system (100) according to any of the preceding clauses, wherein
the coordinating system (120) is configured to additionally send (205) to one or more of the plurality of signing devices (110) the message (124) to be signed and/or a selection (126) for a presignature (115) out of the one or more presignatures (115), and
one or more of the plurality of signing devices (110) is configured to receive from the coordinating system (120)
the message (124) to be signed, and/or
a selection (126) for the presignature (115) out of the one or more presignatures (115) to use.

For example, the coordinating system (120) may be configured to send (205) to each of the signing devices (110) the message (124) to be signed and/or a selection (126) for a presignature (115) out of the one or more presignatures (115). For example, each of the signing devices (110) may be configured to receive from the coordinating system (120) the message (124) to be signed, and/or a selection (126) for the presignature (115) out of the one or more presignatures (115) to use.

Clause 4. A system (100) according to any of the preceding clauses, wherein the presignature (115) out of the one or more presignatures (115) which is used to generate (206) a share (116, 116.1, 116.2, 116.3) of a signature (117) is securely erased from the signing device (110) after being used to generate (206) the share (116, 116.1, 116.2, 116.3) of the signature (117).

Clause 5. A system (100) according to any of the preceding clauses, wherein each of the plurality of signing devices (110) is further configured to
communicate with one or more of the plurality of signing devices (110).

Clause 6. The system (100) according to any of the preceding clauses, wherein each (j) of the plurality of signing devices (110) is further configured, during the computing (201) of the one or more presignatures (115), to
generate a message (g^{k}^{_{i,j}}) corresponding to a share (k_{i,j}) of an integer (kᵢ), using a generator (g) of a group, and send the generated message (g^{k}^{_{i,j}}) to another signing device (140) out of the plurality of signing devices (110),
generate a share

$$( {k}_{i , j}^{′} )$$

of an inverse of the random integer (kᵢ), and store (204) the generated share

$$( {k}_{i , j}^{′} )$$

of the inverse of the random integer (kᵢ) as part of the one or more presignatures (115).

Clause 7. The system (100) according to any of the preceding clauses, wherein each of the plurality of signing devices (110) is further configured to, during the computing (201) of the one or more presignatures (115),
generate one or more multiplication triples, wherein each of the one or more multiplication triples comprises shares of one or more random integers,
generate a share of an inverse of a random integer from one or more of the multiplication triples.

Clause 8. The system (100) according to Clause 7, wherein each (a_{i,j}, k_{i,j}, w_{i,j}) of the multiplication triples comprises shares (a_{i,j}, k_{i,j}) of random integers (aᵢ, kᵢ), as well as a share (w_{i,j}) of a product (wᵢ=aᵢ·kᵢ) of the random integers (aᵢ, kᵢ), and each (j) of the plurality of signing devices (110) is further configured to
send the share (w_{i,j}) of the product (wᵢ=aᵢ·kᵢ) of the random integers (aᵢ, kᵢ) to one or more other signing devices (140) out of the plurality of signing devices (110), and
generate a share

$$( {k}_{i , j}^{′} = {w}_{i}^{- 1} \cdot {a}_{i , j} )$$

of the inverse of the random integer (kᵢ) corresponding to a multiplication triple (a_{i,j}, k_{i,j}, w_{i,j}) out of the multiplication triples and an interpolation (wᵢ) of the sent shares (w_{i,j}) of the products (wᵢ=aᵢ·kᵢ) of the random integers (aᵢ, kᵢ) by the plurality of signing devices (110).

Clause 9. The system (100) according to Clause 7 or 8, wherein each (j) of the plurality of signing devices (110) is configured to generate a plurality of multiplication triples, the generating comprising
generating shares of uniform values (aᵢ, kᵢ) and shares of further uniform values (r, β),
generating shares of products (wᵢ=aᵢ·kᵢ) of the uniform values (aᵢ, kᵢ), shares of further products (μᵢ=r·kᵢ) of the uniform values (aᵢ) and the further uniform values (r), and shares of third products (τᵢ=μᵢ·kᵢ) of the further products and the uniform values (kᵢ),
sharing the shares of the further uniform values (r, β) with each of the plurality of signing devices (110),
upon receiving the generated shares of the further uniform values (r, β) from each of the plurality of signing devices (110), generating shares of an expression (T=Σᵢ(τᵢ−r·wᵢ)βⁱ), the expression comprising the generated shares of the third products (τᵢ=μᵢ·kᵢ), the generated shares of the products (wᵢ=aᵢ·kᵢ), and the generated shares of the further uniform values (r, β), sharing the shares of the expression T with each of the plurality of signing devices (110), and verifying if the expression T equals zero,
outputting the generated shares of the uniform values (aᵢ, kᵢ) and the generated shares of the products (wᵢ=aᵢ·kᵢ) of the uniform values (aᵢ, kᵢ) as the generated multiplication triples (a_{i,j}, k_{i,j}, w_{i,j}).

Clause 10. The system (100) according to any of the preceding clauses, wherein the coordinating system (120) stores at least one public key (143) corresponding to the multiple private keys and is further configured to
after combining (208) the generated shares (116, 116.1, 116.2, 116.3) of the signature (117) for the message (124) into the signature (117) for the message (124), verify (209) the signature (117) using a public key (143) out of the at least one public key (143) corresponding to the selected private key (125) of the multiple private keys.

Clause 11. The system (100) according to any of the preceding clauses, wherein the presigning phase (210) further comprises generating and locally storing shares of a zero value, and wherein generating (206) the share (116, 116.1, 116.2, 116.3) of the signature (117) for a message (124) in the signing phase (220) comprises adding a generated share of the zero value.

Clause 12. The system (100) according to any of the preceding clauses, further comprising
one or more devices (130) designated to a set of the signing devices (110), wherein each of the one or more devices (130) is configured to
obtain a key, and
send the key to each signing device (110) out of the designated set of signing devices (110).

Clause 13. The system (100) according to Clause 12, wherein each of the plurality of signing devices (110) is further configured to
receive a key from a device (130) designated to a set of signing devices (110) comprising the signing device (110),
generate shares of a zero value using the received key.

Clause 14. The system (100) according to Clause 12 or Clause 13, wherein each of the plurality of signing devices (110) is further configured to
receive a key from a device (130) designated to a set of signing devices (110) comprising the signing device, (110)
generate shares of a random value using the received key.

Clause 15. The system (100) according to any of the preceding clauses, wherein the multiple private keys result from a distributed key generation protocol.

Clause 16. A signing device (110), storing a share (141) of each of multiple private keys, which comprises one or more processors (111) and one or more storage devices (112) storing instructions that, when executed by the one or more processors (111), cause the one or more processors (111) to perform operations for
in a presigning phase (210),
computing (201) one or more presignatures (115), independent of the multiple private keys, and
locally storing (204) the one or more presignatures (115),

and
in a signing phase (220), upon receiving from a coordinating system (120) a selection (125) for a private key out of the multiple private keys,
generating (206) a share (116, 116.1, 116.2, 116.3) of a signature (117) for a message (124), using a presignature (115) out of the one or more presignatures (115) computed (201) and stored (204) in the presigning phase (210), and
sending (207) the generated share (116, 116.1, 116.2, 116.3) of the signature (117) for the message (124) to the coordinating system (120).

Clause 17. A coordinating system (120), comprising one or more processors (121) and one or more storage devices (122), storing instructions that, when executed by the one or more processors (121), cause the one or more processors (121) to perform operations for
sending (205) a selection (125) for a private key out of multiple private keys to one or more of a plurality of signing devices (110),
upon receiving generated shares (116, 116.1, 116.2, 116.3) of a signature (117) for a message (124) from one or more of the signing devices (110), combining (208) the generated shares (116, 116.1, 116.2, 116.3) of the signature (117) for the message (124) into the signature (117).

For example, the coordinating system (120) may be configured to send a selection (125) for a private key out of multiple private keys to each of the plurality of signing devices (110). For example, each of the plurality of signing devices (110) may be configured to generate shares (116, 116.1, 116.2, 116.3) of a signature (117) for a message (124) and/or send the generated shares (116, 116.1, 116.2, 116.3) of a signature (117) for a message (124), and/or the coordinating system (120) may be configured to receive generated shares (116, 116.1, 116.2, 116.3) of a signature (117) for a message (124) from each of the signing devices (110).

Clause 18. A presignature and signature generation method (400) for a signing device (110), the signing device (110) storing a share (141) of each of multiple private keys, the method (400) comprising
in a presigning phase (210),
computing (201) one or more presignatures (115), independent of the multiple private keys, and
locally storing (204) the one or more presignatures (115),

and
in a signing phase (220), upon receiving (401) from a coordinating system (120) a selection (125) for a private key out of the multiple private keys,
generating (206) a share (116, 116.1, 116.2, 116.3) of a signature (117) for a message (124), using a presignature (115) out of the one or more presignatures (115) computed (201) and stored (204) in the presigning phase (210), and
sending (207) the generated share (116, 116.1, 116.2, 116.3) of the signature (117) for the message (124) to the coordinating system (120).

Clause 19. A signature generation method (500) for a coordinating system (120), comprising
sending (205) a selection (125) for a private key out of multiple private keys to one or more of a plurality of signing devices (110),
upon receiving (501) generated shares (116, 116.1, 116.2, 116.3) of a signature (117) for a message (124) from one or more of the signing devices (110), combining (208) the generated shares (116, 116.1, 116.2, 116.3) of the signature (117) for the message (124) into the signature (117).

For example, the coordinating system (120) may be configured to send a selection (125) for a private key out of multiple private keys to each of the plurality of signing devices (110). For example, each of the plurality of signing devices (110) may be configured to generate shares (116, 116.1, 116.2, 116.3) of a signature (117) for a message (124) and/or send the generated shares (116, 116.1, 116.2, 116.3) of a signature (117) for a message (124), and/or the coordinating system (120) may be configured to receive generated shares (116, 116.1, 116.2, 116.3) of a signature (117) for a message (124) from each of the signing devices (110).

Clause 20. A non-transitory computer readable medium (1000, 1001) comprising data representing instructions, which when executed by a processor system (1140), cause the processor system (1140) to perform a presignature and signature generation method (400) for a signing device (110), the signing device (110) storing a share (141) of each of multiple private keys, the method (400) comprising
in a presigning phase (210),
computing (201) one or more presignatures (115), independent of the multiple private keys, and
locally storing (204) the one or more presignatures (115),

and
in a signing phase (220), upon receiving (401) from a coordinating system (120) a selection (125) for a private key out of the multiple private keys,
generating (206) a share (116, 116.1, 116.2, 116.3) of a signature (117) for a message (124), using a presignature (115) out of the one or more presignatures (115) computed (201) and stored (204) in the presigning phase (210), and
sending (207) the generated share (116, 116.1, 116.2, 116.3) of the signature (117) for the message (124) to the coordinating system (120).

Clause 21. A non-transitory computer readable medium (1000, 1001) comprising data representing instructions, which when executed by a processor system (1140), cause the processor system (1140) to perform a signature generation method (500) for a coordinating system (120), the method (500) comprising
sending (205) a selection (125) for a private key out of multiple private keys to one or more of a plurality of signing devices (110),
upon receiving (501) generated shares (116, 116.1, 116.2, 116.3) of a signature (117) for a message (124) from one or more of the signing devices (110), combining (208) the generated shares (116, 116.1, 116.2, 116.3) of the signature (117) for the message (124) into the signature (117).

For example, the coordinating system (120) may be configured to send a selection (125) for a private key out of multiple private keys to each of the plurality of signing devices (110). For example, each of the plurality of signing devices (110) may be configured to generate shares (116, 116.1, 116.2, 116.3) of a signature (117) for a message (124) and/or send the generated shares (116, 116.1, 116.2, 116.3) of a signature (117) for a message (124), and/or the coordinating system (120) may be configured to receive generated shares (116, 116.1, 116.2, 116.3) of a signature (117) for a message (124) from each of the signing devices (110).

Clause 22. A non-transitory computer readable medium (1000, 1001) storing one or more presignatures (115), the one or more presignatures (115) being computed (201) by a signing device (110), the signing device (110) storing a share (141) of each of multiple private keys, the signing device (110) being configured to compute (201) the one or more presignatures (115), independent of the multiple private keys, the signing device (110) being further configured to locally store (204) the one or more presignatures (115).

It should be noted that the above-mentioned embodiments illustrate rather than limit the presently disclosed subject matter, and that those skilled in the art will be able to design many alternative embodiments.

In the claims, any reference signs placed between parentheses shall not be construed as limiting the claim. Use of the verb ‘comprise’ and its conjugations does not exclude the presence of elements or steps other than those stated in a claim. The article ‘a’ or ‘an’ preceding an element does not exclude the presence of a plurality of such elements. Expressions such as “at least one of” when preceding a list of elements represent a selection of all or of any subset of elements from the list. For example, the expression, “at least one of A, B, and C” should be understood as including only A, only B, only C, both A and B, both A and C, both B and C, or all of A, B, and C. The presently disclosed subject matter may be implemented by hardware comprising several distinct elements, and by a suitably programmed computer. In the device claim enumerating several parts, several of these parts may be embodied by one and the same item of hardware. The mere fact that certain measures are recited in mutually different dependent claims does not indicate that a combination of these measures cannot be used to advantage.

In the claims references in parentheses refer to reference signs in drawings of exemplifying embodiments or to formulas of embodiments, thus increasing the intelligibility of the claim. These references shall not be construed as limiting the claim.

1. A system (100) for presignature and signature generation, the system (100) comprising a plurality of signing devices (110) and a coordinating system (120), wherein each of the plurality of signing devices (110) stores a share (141) of each of multiple private keys, wherein
each of the plurality of signing devices (110) comprises one or more processors (111) and one or more storage devices (112) storing instructions that, when executed by the one or more processors (111), cause the one or more processors (111) to perform operations for
in a presigning phase (210),
computing (201) one or more presignatures (115), independent of the multiple private keys, and
locally storing (204) the one or more presignatures (115),
and
in a signing phase (220), upon receiving from the coordinating system (120) a selection (125) for a private key out of the multiple private keys,
generating (206) a share (116, 116.1, 116.2, 116.3) of a signature (117) for a message (124), using a presignature (115) out of the one or more presignatures (115) computed (201) and stored (204) in the presigning phase (210), and
sending (207) the generated share (116, 116.1, 116.2, 116.3) of the signature (117) for the message (124) to the coordinating system (120), and
the coordinating system (120) comprises one or more processors (121) and one or more storage devices (122) storing instructions that, when executed by the one or more processors (121), cause the one or more processors (121) to perform operations for
sending (205) the selection (125) for a private key to one or more of the signing devices (110),
upon receiving the generated shares (116, 116.1, 116.2, 116.3) of the signature (117) for a message (124) from one or more of the signing devices (110), combining (208) the generated shares (116, 116.1, 116.2, 116.3) of the signature (117) for the message (124) into a signature (117).

2. A system (100) according to claim 1, wherein each of the plurality of signing devices (110) is configured to, in the presigning phase (210), perform computations (114) resulting in a plurality of presignatures (115), each of the plurality of presignatures (115) being independent of the multiple private keys.

3. A system (100) according to claim 1, wherein
the coordinating system (120) is configured to additionally send (205) to one or more of the plurality of signing devices (110) the message (124) to be signed and/or a selection (126) for a presignature (115) out of the one or more presignatures (115), and
one or more of the plurality of signing devices (110) is configured to receive from the coordinating system (120)
the message (124) to be signed, and/or
a selection (126) for the presignature (115) out of the one or more presignatures (115) to use.

4. A system (100) according to claim 1, wherein the presignature (115) out of the one or more presignatures (115) which is used to generate (206) a share (116, 116.1, 116.2, 116.3) of a signature (117) is securely erased from the signing device (110) after being used to generate (206) the share (116, 116.1, 116.2, 116.3) of the signature (117).

5. A system (100) according to claim 1, wherein each of the plurality of signing devices (110) is further configured to
communicate with one or more of the plurality of signing devices (110).

6. The system (100) according to claim 1, wherein each (j) of the plurality of signing devices (110) is further configured, during the computing (201) of the one or more presignatures (115), to
generate a message (g^{k}^{_{i,j}}) corresponding to a share (k_{i,j}) of an integer (kᵢ), using a generator (g) of a group, and send the generated message (g^{k}^{_{i,j}}) to another signing device (140) out of the plurality of signing devices (110),
generate a share
$$( {k}_{i , j}^{′} )$$
of an inverse of the random integer (kᵢ), and store (204) the generated share
$$( {k}_{i , j}^{′} )$$
of the inverse of the random integer (kᵢ) as part of the one or more presignatures (115).

7. The system (100) according to claim 1, wherein each of the plurality of signing devices (110) is further configured to, during the computing (201) of the one or more presignatures (115),
generate one or more multiplication triples, wherein each of the one or more multiplication triples comprises shares of one or more random integers,
generate a share of an inverse of a random integer from one or more of the multiplication triples.

8. The system (100) according to claim 7, wherein each (a_{i,j}, k_{i,j}, w_{i,j}) of the multiplication triples comprises shares (a_{i,j}, k_{i,j}) of random integers (aᵢ, kᵢ), as well as a share (w_{i,j}) of a product (wᵢ=aᵢ·kᵢ) of the random integers (aᵢ,kᵢ), and each (j) of the plurality of signing devices (110) is further configured to
send the share (w_{i,j}) of the product (wᵢ=aᵢ·kᵢ) of the random integers (aᵢ, kᵢ) to one or more other signing devices (140) out of the plurality of signing devices (110), and
generate a share
$$( {k}_{i , j}^{′} = {w}_{i}^{- 1} \cdot {a}_{i , j} )$$
of the inverse of the random integer (kᵢ) corresponding to a multiplication triple (a_{i,j}, k_{i,j}, w_{i,j}) out of the multiplication triples and an interpolation (wᵢ) of the sent shares (w_{i,j}) of the products (wᵢ=aᵢ·kᵢ) of the random integers (aᵢ, kᵢ) by the plurality of signing devices (110).

9. The system (100) according to claim 7, wherein each (j) of the plurality of signing devices (110) is configured to generate a plurality of multiplication triples, the generating comprising
generating shares of uniform values (aᵢ, kᵢ) and shares of further uniform values (r, β),
generating shares of products (wᵢ=aᵢ·kᵢ) of the uniform values (aᵢ, kᵢ), shares of further products (μᵢ=r·kᵢ) of the uniform values (at) and the further uniform values (r), and shares of third products (τᵢ=μᵢ·kᵢ) of the further products and the uniform values (kᵢ),
sharing the shares of the further uniform values (r, β) with each of the plurality of signing devices (110),
upon receiving the generated shares of the further uniform values (r, β) from each of the plurality of signing devices (110), generating shares of an expression (T=Σᵢ(τᵢ−r·wᵢ)βⁱ), the expression comprising the generated shares of the third products (τᵢ=μᵢ·kᵢ), the generated shares of the products (wᵢ=aᵢ·kᵢ), and the generated shares of the further uniform values (r, β), sharing the shares of the expression T with each of the plurality of signing devices (110), and verifying if the expression T equals zero,
outputting the generated shares of the uniform values (aᵢ, kᵢ) and the generated shares of the products (wᵢ=aᵢ·kᵢ) of the uniform values (aᵢ, kᵢ) as the generated multiplication triples (a_{i,j}, k_{i,j}, w_{i,j}).

10. The system (100) according to claim 1, wherein the coordinating system (120) stores at least one public key (143) corresponding to the multiple private keys and is further configured to
after combining (208) the generated shares (116, 116.1, 116.2, 116.3) of the signature (117) for the message (124) into the signature (117) for the message (124), verify (209) the signature (117) using a public key (143) out of the at least one public key (143) corresponding to the selected private key (125) of the multiple private keys.

11. The system (100) according to claim 1, wherein the presigning phase (210) further comprises generating and locally storing shares of a zero value, and wherein generating (206) the share (116, 116.1, 116.2, 116.3) of the signature (117) for a message (124) in the signing phase (220) comprises adding a generated share of the zero value.

12. The system (100) according to claim 1, further comprising
one or more devices (130) designated to a set of the signing devices (110), wherein each of the one or more devices (130) is configured to
obtain a key, and
send the key to each signing device (110) out of the designated set of signing devices (110).

13. The system (100) according to claim 12, wherein each of the plurality of signing devices (110) is further configured to
receive a key from a device (130) designated to a set of signing devices (110) comprising the signing device (110),
generate shares of a zero value using the received key.

14. The system (100) according to claim 12, wherein each of the plurality of signing devices (110) is further configured to
receive a key from a device (130) designated to a set of signing devices (110) comprising the signing device, (110)
generate shares of a random value using the received key.

15. The system (100) according to claim 1, wherein the multiple private keys result from a distributed key generation protocol.

16. A signing device (110), storing a share (141) of each of multiple private keys, which comprises one or more processors (111) and one or more storage devices (112) storing instructions that, when executed by the one or more processors (111), cause the one or more processors (111) to perform operations for
in a presigning phase (210),
computing (201) one or more presignatures (115), independent of the multiple private keys, and
locally storing (204) the one or more presignatures (115),
and
in a signing phase (220), upon receiving from a coordinating system (120) a selection (125) for a private key out of the multiple private keys,
generating (206) a share (116, 116.1, 116.2, 116.3) of a signature (117) for a message (124), using a presignature (115) out of the one or more presignatures (115) computed (201) and stored (204) in the presigning phase (210), and
sending (207) the generated share (116, 116.1, 116.2, 116.3) of the signature (117) for the message (124) to the coordinating system (120).

17. A coordinating system (120), comprising one or more processors (121) and one or more storage devices (122), storing instructions that, when executed by the one or more processors (121), cause the one or more processors (121) to perform operations for
sending (205) a selection (125) for a private key out of multiple private keys to one or more of a plurality of signing devices (110),
upon receiving generated shares (116, 116.1, 116.2, 116.3) of a signature (117) for a message (124) from one or more of the signing devices (110), combining (208) the generated shares (116, 116.1, 116.2, 116.3) of the signature (117) for the message (124) into the signature (117).

18. A presignature and signature generation method (400) for a signing device (110), the signing device (110) storing a share (141) of each of multiple private keys, the method (400) comprising
in a presigning phase (210),
computing (201) one or more presignatures (115), independent of the multiple private keys, and
locally storing (204) the one or more presignatures (115),
and
in a signing phase (220), upon receiving (401) from a coordinating system (120) a selection (125) for a private key out of the multiple private keys,
generating (206) a share (116, 116.1, 116.2, 116.3) of a signature (117) for a message (124), using a presignature (115) out of the one or more presignatures (115) computed (201) and stored (204) in the presigning phase (210), and
sending (207) the generated share (116, 116.1, 116.2, 116.3) of the signature (117) for the message (124) to the coordinating system (120).

19. A signature generation method (500) for a coordinating system (120), comprising
sending (205) a selection (125) for a private key out of multiple private keys to one or more of a plurality of signing devices (110),
upon receiving (501) generated shares (116, 116.1, 116.2, 116.3) of a signature (117) for a message (124) from one or more of the signing devices (110), combining (208) the generated shares (116, 116.1, 116.2, 116.3) of the signature (117) for the message (124) into the signature (117).

20. A non-transitory computer readable medium (1000, 1001) comprising data representing instructions, which when executed by a processor system (1140), cause the processor system (1140) to perform a presignature and signature generation method (400) for a signing device (110), the signing device (110) storing a share (141) of each of multiple private keys, the method (400) comprising
in a presigning phase (210),
computing (201) one or more presignatures (115), independent of the multiple private keys, and
locally storing (204) the one or more presignatures (115),
and
in a signing phase (220), upon receiving (401) from a coordinating system (120) a selection (125) for a private key out of the multiple private keys,
generating (206) a share (116, 116.1, 116.2, 116.3) of a signature (117) for a message (124), using a presignature (115) out of the one or more presignatures (115) computed (201) and stored (204) in the presigning phase (210), and
sending (207) the generated share (116, 116.1, 116.2, 116.3) of the signature (117) for the message (124) to the coordinating system (120).

21. A non-transitory computer readable medium (1000, 1001) comprising data representing instructions, which when executed by a processor system (1140), cause the processor system (1140) to perform a signature generation method (500) for a coordinating system (120), the method (500) comprising
sending (205) a selection (125) for a private key out of multiple private keys to one or more of a plurality of signing devices (110),
upon receiving (501) generated shares (116, 116.1, 116.2, 116.3) of a signature (117) for a message (124) from one or more of the signing devices (110), combining (208) the generated shares (116, 116.1, 116.2, 116.3) of the signature (117) for the message (124) into the signature (117).

22. A non-transitory computer readable medium (1000, 1001) storing one or more presignatures (115), the one or more presignatures (115) being computed (201) by a signing device (110), the signing device (110) storing a share (141) of each of multiple private keys, the signing device (110) being configured to compute (201) the one or more presignatures (115), independent of the multiple private keys, the signing device (110) being further configured to locally store (204) the one or more presignatures (115).
